(19) United States
(12) Patent Application Publication
(10) Pub. No.: US 2026/0277791 A1
(43) Pub. Date: Sep. 17, 2026

(54) MEMORY SYSTEM

(71) Applicant: Kioxia Corporation, Tokyo (JP)

(72) Inventors: Kohei OKUDA, Koganei Tokyo (JP); Toru WATABE, Yokohama Kanagawa (JP); Shinichi KANNO, Ota Tokyo (JP)

(21) Appl. No.: 19/325,019

(22) Filed: Sep. 10, 2025

(30) Foreign Application Priority Data
Mar. 13, 2025 (JP) 2025-039889

(51) Int. Cl. G06F 12/02

(52) U.S. Cl. CPC G06F 12/0246

(57) ABSTRACT

A memory system includes a semiconductor storage device having a buffer memory, a non-volatile memory cell array, a vector calculation circuit, and a controller. The controller is electrically connected to the semiconductor storage device and communicable with a host that is external to the memory system. The controller is configured to store a plurality of N-dimensional vectors (N is an integer more than or equal to one) in the non-volatile memory cell array, receive a query vector, which is N-dimensional, from the host, store the query vector into the buffer memory, control the vector calculation circuit to perform a first vector calculation with respect to the query vector and a first vector among the plurality of N-dimensional vectors stored in the non-volatile memory cell array, and transmit a result of the first vector calculation to the host.

### CROSS-REFERENCE TO RELATED APPLICATIONS

This application is based upon and claims the benefit of priority from Japanese Patent Application No. 2025-039889, filed Mar. 13, 2025, the entire contents of which are incorporated herein by reference.

### FIELD

Embodiments described herein relate generally to a technique of controlling a non-volatile memory.

### BACKGROUND

In recent years, memory systems that include non-volatile memories have become widespread. As one of such memory systems, a solid state drive (SSD) that includes NAND flash memories has been known. SSDs are used as main storages of various computing devices.

A large number of vector data items (vector data) may be stored in non-volatile memories. In this case, for example, a similarity search is performed based on a query vector for searching for vectors similar to the query vector input into a host from among a large number of vector data items stored in a non-volatile memory. The similarity search is used for various purposes, such as data search in generative AI.

The amount of data of each vector is, for example, several kilobytes (KB). Accordingly, a long time is required for data transfer for similarity search from a memory system to a host, and the amount of power consumption is high accordingly. As for the data transfer, a vector read from the non-volatile memory of the memory system is transmitted to the host via a controller for achieving the data transfer. As a method of reducing the time required for the data transfer, for example, a method of increasing the input and output bandwidth (I/O bandwidth) of a path between the controller of the memory system and a random access memory (RAM) in the host is conceivable. However, the I/O bandwidth has an upper limit due to the specification. It is typically difficult to increase the I/O bandwidth. Even if the I/O bandwidth can be increased, the amount of power consumption increases accordingly.

As the generative AI becomes widespread, it is expected that vector data stored in the non-volatile memory will be used in various applications and the amount of data to be stored and the volume of accesses will increase in the future. Consequently, the I/O bandwidth of the path along which data is transferred from the non-volatile memory to the host can be a bottleneck for the vector similarity search. To address such an issue, it is required to provide a new technology that can reduce the time required for data transfer to the host, and reduce the amount of data to be transferred with a smaller amount of power consumption.

### BRIEF DESCRIPTION OF THE DRAWINGS

FIG. 1 is a block diagram showing a configuration example of an information processing system that includes a memory system according to a first embodiment.

FIG. 2 is a block diagram showing a configuration example of an array unit in the memory system according to the first embodiment.

FIG. 3 is a sequence diagram showing an example of an operation of the memory system according to the first embodiment storing vector data from a host and notifying the host of write completion.

FIG. 4 is a sequence diagram showing an example of an operation of the memory system according to the first embodiment computing a query vector from the host and transmitting a calculation result to the host.

FIG. 5 is a block diagram showing a configuration of an information processing system that includes a memory system according to a comparative example.

FIG. 6 is a sequence diagram pertaining to a vector calculation operation between the memory system according to the comparative example and a host.

FIG. 7 shows a calculation example of an inner product in a semiconductor storage device in the memory system according to the first embodiment.

FIG. 8 is a diagram showing an example of logical blocks of an inner product calculation circuit that calculates an inner product in the semiconductor storage device in the memory system according to the first embodiment.

FIG. 9 shows a calculation example for obtaining the norm of a vector in the semiconductor storage device in the memory system according to the first embodiment.

FIG. 10 shows an example of logical blocks of an Euclidean distance calculation circuit that calculates the norm of the vector in the semiconductor storage device in the memory system according to the first embodiment.

FIG. 11 is a flowchart showing an example of procedures of a vector search process executed in the host connected to the memory system according to the first embodiment.

FIG. 12 is a flowchart showing an example of procedures of a request control process executed in the memory system according to the first embodiment.

FIG. 13 is a flowchart showing an example of procedures of a response control process executed in the memory system according to the first embodiment.

FIG. 14 is a flowchart showing an example of procedures of a calculation control process executed in the memory system according to the first embodiment.

FIG. 15 is a block diagram showing a configuration example of a memory system according to a second embodiment.

FIG. 16 is a block diagram showing a configuration example of a memory system according to a third embodiment.

### DETAILED DESCRIPTION

An embodiment of the present invention is directed to providing a memory system that can reduce the amount of data to be transferred from the memory system to a host when retrieving a vector similar to a query vector from among vectors in the memory system and outputting the retrieved vector.

In general, according to an embodiment, a memory system includes a semiconductor storage device having a buffer memory, a non-volatile memory cell array, and a vector calculation circuit, and a controller. The controller is electrically connected to the semiconductor storage device and communicable with a host that is external to the memory system. The controller is configured to store a plurality of N-dimensional vectors (N is an integer more than or equal to one) in the non-volatile memory cell array, receive a query vector, which is N-dimensional, from the host, store the query vector into the buffer memory, control the vector calculation circuit to perform a first vector calculation with respect to the query vector and a first vector among the plurality of N-dimensional vectors stored in the non-volatile memory cell array, and transmit a result of the first vector calculation to the host.

Embodiments are described below with reference to the drawings.

### First Embodiment

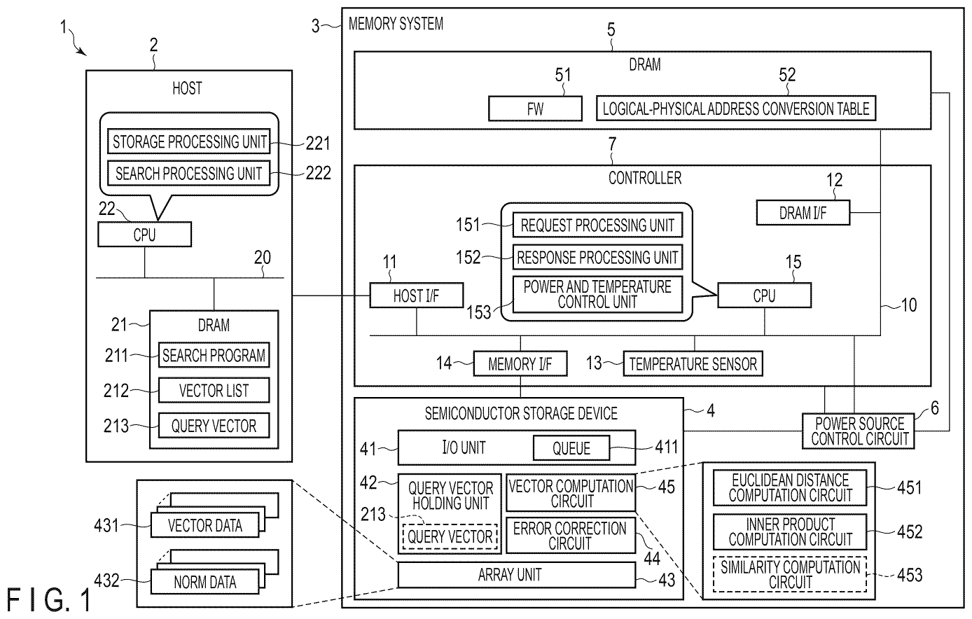

First, referring to FIG. 1, a configuration example of an information processing system that includes a memory system according to a first embodiment is described. The information processing system 1 is a system for performing vector similarity search. The similarity search is a search that identifies one or more vectors similar to a query vector from among a plurality of vectors. The plurality of vectors are vectors that can serve as targets of the similarity search. The plurality of vectors and the query vector are N-dimensional vectors. N is, for example, an integer greater than or equal to one.

The information processing system 1 includes, for example, a host device 2, and a memory system 3. Hereinafter, the host device 2 is also called the host 2.

The host 2 performs a similarity search on a plurality of vectors stored in the memory system (e.g., multiple items of vector data 431) based on data 213 of an input query vector. The host 2 is, for example, a server computer that performs the similarity search, based on the data 213 of a query vector received from each of client computers connected thereto. The host 2 may be a personal computer that performs the similarity search, based on the data 213 of the query vector input into the host 2. Hereinafter, the data 213 of the query vector is also simply called the query vector 213.

The memory system 3 is a storage device configured to write data to a semiconductor storage device 4, and read data from the semiconductor storage device 4. The memory system 3 is also called a semiconductor storage device. The semiconductor storage device 4 is, for example, a memory chip (memory die) that includes a non-volatile memory. The non-volatile memory is an NAND flash memory. The memory system 3 is implemented as, for example, an SSD that includes the semiconductor storage device 4 including an NAND flash memory.

The memory system 3 can be used as a storage of the host 2. For example, the memory system 3 may be a computer storage drive (CSD). The computer storage drive includes a namespace (compute name space) for storing programs of subsystems, and a namespace (memory namespace) controlled by the programs, as memory areas, in addition to a typical namespace. The memory system 3 may output results of similarity searches in parallel. The memory system 3 may be internally included in the host 2, or be connected to the host 2 via a cable or a network.

An interface for connecting the host 2 and the memory system 3 to each other complies with, for example, a standard, such as PCI Express™ (PCIe™), Ethernet™, Fibre channel, or NVM Express™ (NVMe™).

### (Configuration of Host 2)

The host 2 includes, for example, a dynamic random access memory (DRAM) 21, and a central processing unit (CPU) 22. The DRAM 21 and the CPU 22 are connected to each other via a bus 20, for example.

The DRAM 21 is, for example, a volatile memory. The memory area of the DRAM 21 is allocated as, for example, a storage area for programs to be executed by the CPU 22, and a storage area for a vector list 212 and the query vector 213.

The programs to be executed by the CPU 22 are an operating system, drivers, and various application programs. The application programs include a search program 211. The search program 211 is a program for accepting an input of the query vector 213, and performing the similarity search based on the input query vector 213.

The vector list 212 is data indicating a list of vectors serving as targets of the similarity search. The vectors serving as targets of the similarity search may be, for example, all the vectors stored in the semiconductor storage device 4 (i.e., all the items of vector data 431), or vectors narrowed down from among these vectors. The vector list 212 may include, for example, information (vector IDs) that can uniquely identify the vectors serving as targets of the similarity search. The vector list 212 may include information indicating logical addresses where the vectors serving as targets of the similarity search are stored. The logical addresses are addresses used by the host 2 in order to designate the addresses of a storage area of the memory system 3. The logical address is, for example, a logical block address (LBA). Hereinafter, the vectors serving as targets of the similarity search are also called search target vectors.

The similarity between the query vector 213 and the search target vector is represented by, for example, an indicator using cosine (COS) similarity. Specifically, by the following Formula (1), the similarity between the query vector 213 and the search target vector is calculated.

$$\begin{matrix}Similarity ( a , b ) = 1 - \frac{a \cdot b}{‖ a ‖ ‖ b ‖} \\ = 1 \frac{{\sum }_{i = 1}^{N} {a}_{i} {b}_{i}}{\sqrt{{\sum }_{i = 1}^{N} {a}_{i}^{2}} \sqrt{{\sum }_{i = 1}^{N} {b}_{j}^{2}}}\end{matrix} \qquad Formula ( 1 )$$

In Formula (1), “a” represents the query vector 213, and “b” represents the search target vector. The query vector a has N elements that are a₁, . . . , a_{N}. The search target vector b has N elements that are b₁, . . . , b_{N}. a·b is the inner product of the query vector 213 and the search target vector. ∥a∥ is the norm (Euclidean norm) of the query vector 213. ∥b∥ is the norm of the search target vector. The norm of a vector indicates the length of the vector itself. In other words, the norm of a vector indicates the length from the origin (zero vector) to the vector (i.e., the Euclidean distance). The similarity is, for example, a floating-point number.

The distance between the query vector 213 and the search target vector may be used as the similarity between these two vectors. For example, the Euclidean distance or the Manhattan distance is used as the length between vectors. The Euclidean distance is the Euclidean norm of the distance between two vectors. For example, the Euclidean distance between the query vector 213 and the search target vector is calculated by the following Formula (2).

$$\sqrt{{\sum }_{i = 1}^{N} {( {a}_{i} - {b}_{i} )}^{2}} \qquad Formula ( 2 )$$

An example of calculating the indicator using the cosine similarity indicated by Formula (1) as the similarity between the query vector 213 and the search target vector is mainly described below.

It is noted that instead of the DRAM 21, for example, a static random access memory (SRAM) may be provided for the host 2. Alternatively, in addition to the DRAM 21, an SRAM may be provided.

The CPU 22 is, for example, at least one processor. The CPU 22 controls the operations of various components in the host 2. Specifically, the CPU 22 functions as a storage processing unit 221 and a search processing unit 222. For example, the CPU 22 functions as these components 221 and 222 by executing the search program 211.

The storage processing unit 221 performs a process for requesting the memory system 3 to store the plurality of vectors (multiple items of vector data 431) that can serve as targets of the similarity search to the semiconductor storage device 4. Specifically, the storage processing unit 221 issues, for example, a write request for the vector data 431, to the memory system 3.

The search processing unit 222 performs a process for performing the similarity search on the plurality of vectors stored in the semiconductor storage device 4, based on the query vector 213. Specifically, the search processing unit 222 determines, as a search target vector, one vector sequentially selected from the beginning of the vector list 212, for example. The search processing unit 222 then issues a calculation request for the query vector 213 and the determined search target vector, to the memory system 3. The calculation request is a request for performing a calculation of at least part of calculation for obtaining the similarity between the query vector 213 and the search target vector stored in the semiconductor storage device 4.

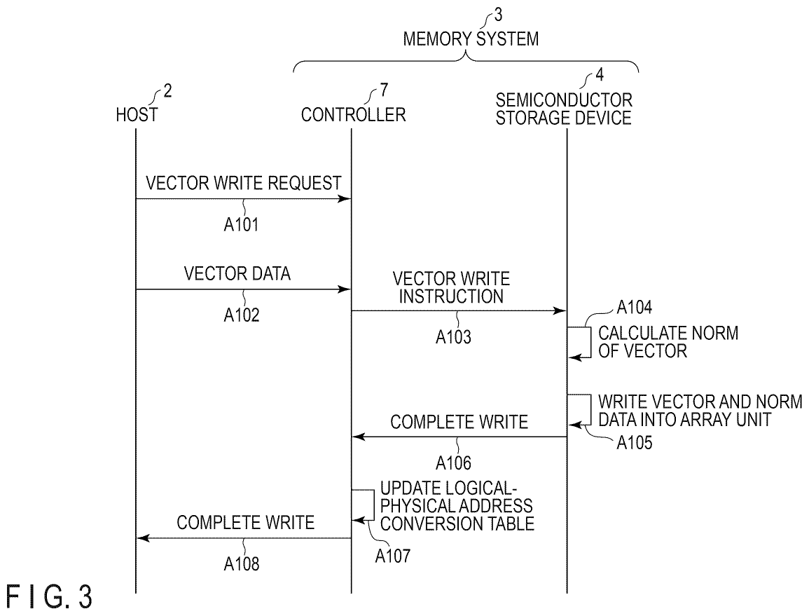

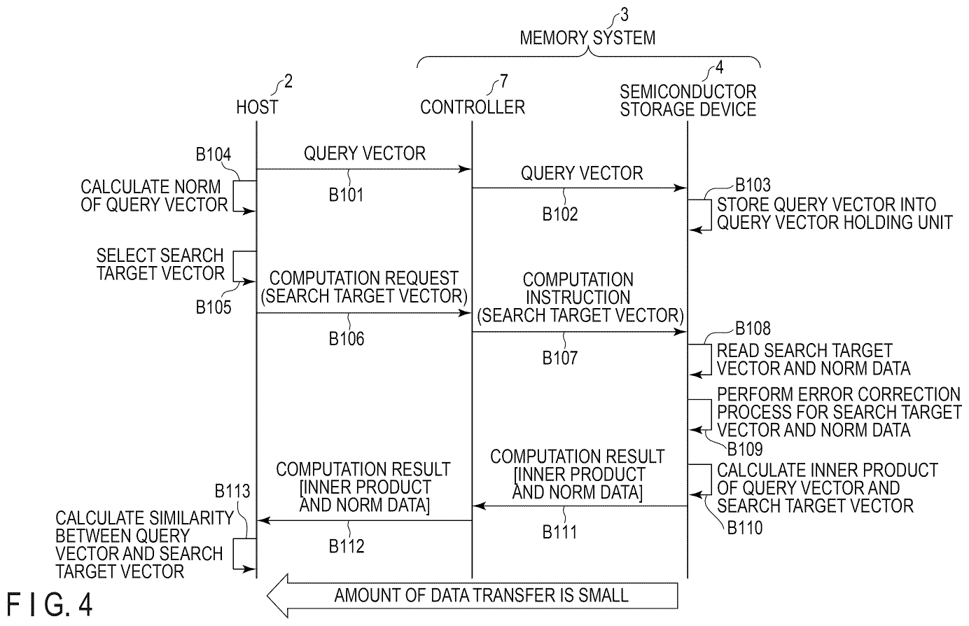

The more specific operations of the storage processing unit 221 and the search processing unit 222 are described below with reference to FIGS. 3 and 4. It is noted that the storage processing unit 221 and the search processing unit 222 may be implemented by dedicated hardware in the host 2.

### (Configuration of Memory System 3)

The memory system 3 includes, for example, the semiconductor storage device 4, a DRAM 5, a power source control circuit 6, and a controller 7.

The semiconductor storage device 4 is a storage device that includes a volatile memory that temporarily stores data, and a non-volatile memory that stores data in a non-volatile manner. The semiconductor storage device 4 includes, for example, an I/O unit 41, a query vector storing unit 42, an array unit 43, an error correction circuit 44, and a vector calculation circuit 45.

The I/O unit 41 is a circuit that controls input and output of data into and from the semiconductor storage device 4. The I/O unit 41 can instruct each component in the semiconductor storage device 4 to perform an operation in response to data input into the semiconductor storage device 4 (data write operation), and an operation in response to data output from the semiconductor storage device 4 (data read operation).

The data input into the semiconductor storage device 4 is, for example, an instruction, the query vector 213, or data to be written to the array unit 43. The instruction is, for example, a data write instruction, a data read instruction, an instruction for storing the query vector 213, or an instruction for vector calculation (vector calculation instruction). The data to be written to the array unit 43 is, for example, data of a vector (vector data 431). Hereinafter, the vector data 431 is also called the vector 431.

The data output from the semiconductor storage device 4 is a response to an instruction, or data read from the array unit 43. The response to the instruction is, for example, a data write completion signal, a data read completion signal, or a result of vector calculation. The data read from the array unit 43 is, for example, norm data 432 corresponding to the vector data 431.

The norm data 432 includes, for example, at least any one of data that indicates the norm of the corresponding vector, data that assists calculation of the norm of the corresponding vector, data that indicates the Euclidean distance between the corresponding vector and another vector (e.g., the query vector 213), and data that assists calculation of the Euclidean distance between the corresponding vector and another vector. The data that assists calculation of the norm is data that indicates a value obtained in the middle of a process of calculating the norm. More specifically, the data that assists the calculation of the norm is, for example, data that indicates a value obtained by calculation that is norm calculation from which root calculation (square root calculation) is excluded. This applies similarly to the data that assists the calculation of the Euclidean distance. It is noted that the Euclidean distance may be replaced with the Manhattan distance. In the case of using the similarity (COS similarity) indicated by Formula (1), the norm data 432 includes, for example, the data that indicates the norm of the corresponding vector, or the data that assists the calculation of the norm.

The I/O unit 41 may include a plurality of queues that can each store one or more instructions. The I/O unit 41 can cause the components in the semiconductor storage device 4 to execute operations according to the respective instructions stored in the queues in parallel. Specifically, the I/O unit 41 can cause execution of, for example, reading of the vector data 431 from the array unit 43 according to the data read instruction, and calculation by the vector calculation circuit 45 according to the instruction for vector calculation in parallel.

The query vector storing unit 42 is implemented by, for example, a volatile memory, such as a RAM. The query vector storing unit 42 may be implemented by, for example, a register. The query vector storing unit 42 stores the query vector 213 received by the controller 7 from the host 2 and input from the controller 7 through the I/O unit 41. It is noted that the query vector 213 may be stored in any storage area (e.g., an existing buffer memory) in the semiconductor storage device 4 instead of the query vector storing unit 42.

The array unit 43 is a memory cell array including a plurality of non-volatile memory cells. The array unit 43 is configured with one or more non-volatile memory chips. The array unit 43 stores, for example, a plurality of vectors (i.e., multiple items of vector data 431), and multiple items of norm data 432 corresponding to the respective vectors.

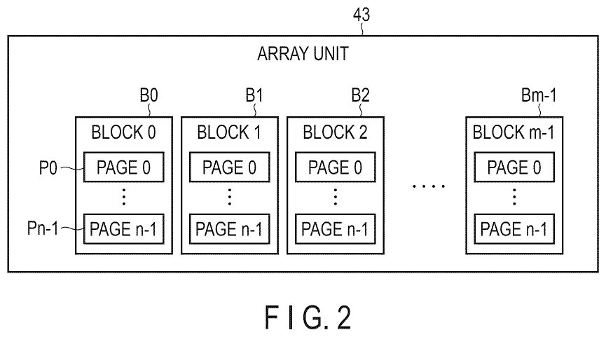

FIG. 2 is a block diagram showing a configuration example of the array unit 43.

The array unit 43 includes a plurality of blocks B0, B1, B2, . . . , Bm−1 obtained by dividing the non-volatile memory cell array with a predetermined size. Each of the blocks B0, B1, B2, . . . , Bm−1 of the non-volatile memory functions as a minimum unit for erasing the stored data in a block-by-block basis. The block may be called an erase block or a physical block. Each of the blocks B0, B1, B2, . . . , Bm−1 includes a plurality of pages P0, . . . , Pn−1. Each of the pages P0, . . . , Pn−1 includes a plurality of memory cells connected to a single word line. Each of the pages P0, . . . , Pn−1 functions as a unit of a data write operation and a data read operation. The word line may functions as a unit of a data write operation and a data read operation.

The number of program/erase cycles (the number of P/E cycles) for each block has an upper limit, which is called the maximum number of P/E cycles. One P/E cycle for a certain block includes a data erase operation for bringing all the memory cells in the block into an erased state, and a program operation for writing data to each page in the block.

The multiple items of vector data 431 are arranged to be aligned in the block, for example. Specifically, multiple items of vector data 431 are arranged in a specific order such that each item of the vector data 431 does not span pages, for example. That is, each of data items of vectors is arranged (stored) in any page among the pages included in the block. Specifically, in a case where the total amount of multiple items of vector data 431 is an amount exceeding one page, the storage processing unit 221 of the host 2 issues an instruction with an amount not exceeding one page to the controller 7 for arrangement that does not span pages. Alternatively, according to an instruction from the I/O unit 41, the multiple items of vector data 431 may be arranged so as to span sequential pages or different pages.

Alternatively, a plurality of combinations of the vector data 431 and the norm data 432 corresponding to the vector data 431 may be arranged so as to be aligned in the block. That is, each of the combinations of the vector data 431 and the norm data 432 corresponding to the vector data 431 may be arranged in any page among the pages included in the block. Specifically, in a case where the total amount of the combinations of the vector data 431 and the norm data 432 is an amount exceeding one page, the storage processing unit 221 of the host 2 issues an instruction with an amount not exceeding one page to the controller 7 for arrangement that does not span pages. Alternatively, according to an instruction from the I/O unit 41, the combinations of the vector data 431 and the norm data 432 may be arranged so as to span sequential pages or different pages.

The description returns to FIG. 1.

The error correction circuit 44 is a circuit that performs an error correction process for data read from the array unit 43. The data read from the array unit 43 is, for example, at least any one of the vector data 431 and the norm data 432. The error correction circuit 44 can transmit the vector data 431 having been subjected to the error correction process, to the I/O unit 41 or the vector calculation circuit 45. The error correction circuit 44 can transmit the norm data 432 having been subjected to the error correction process, to the I/O unit 41 or the vector calculation circuit 45.

The vector calculation circuit 45 is a circuit that performs calculation (hereinafter, also called vector calculation) using the data 213 of the query vectors stored in the query vector storing unit 42, and the vector data 431 stored in the array unit 43. The vector calculation includes, for example, calculation of the norms of vectors, and calculation of the inner product of two vectors. The calculation of the inner product has an object to convert two vectors into a scalar value. The inner product is also called the scalar product. It is noted that the vector calculation may further include at least one of calculation of the distance (e.g., the Euclidean distance or the Manhattan distance) between two vectors, and similarity calculation of two vectors.

Specifically, the vector calculation circuit 45 includes, for example, an Euclidean distance calculation circuit 451, and an inner product calculation circuit 452. The Euclidean distance calculation circuit 451 and the inner product calculation circuit 452 may be achieved as a physically divided two circuits, or achieved as one integrated circuit.

The Euclidean distance calculation circuit 451 is a circuit that generates the norm data 432. For example, the Euclidean distance calculation circuit 451 functions as a circuit that calculates (norm calculation) the norm of the vector described above. Specifically, the Euclidean distance calculation circuit 451 uses, for example, the data 431 of the vector to be written to the array unit 43 to calculate the norm of the vector. Alternatively, the Euclidean distance calculation circuit 451 may calculate a value that assists norm calculation. The norm data 432 that indicates the calculated norm of the vector, or the norm data 432 that indicates the value assisting the norm calculation is written along with the data 431 of the vector to the array unit 43. It is noted that the norm calculation of the vector can be implemented by a circuit common to that for Euclidean distance calculation. Accordingly, the circuit that calculates the norm of the vector is herein represented as the Euclidean distance calculation circuit 451 for convenience. The circuit that calculates the norm of the vector may be provided separately from the Euclidean distance calculation circuit 451. The norm of the vector or the value assisting the norm calculation may be calculated by the host 2 (e.g., the storage processing unit 221). In this case, the norm of the vector or the value assisting the norm calculation is added as auxiliary information to the vector data 431.

Likewise, the Euclidean distance calculation circuit 451 may calculate the norm of the query vector 213, or the value assisting the norm calculation of the query vector 213, using the data of the query vector 213 stored in the query vector storing unit 42. The norm data indicating the norm of the query vector 213 is stored in the query vector storing unit 42, for example. Alternatively, the norm of the query vector 213 may be stored in any storage area in the semiconductor storage device 4. It is noted that the norm of the query vector 213 or the value assisting the norm calculation may be calculated by the host 2 (e.g., the search processing unit 222). In this case, the norm of the query vector 213 or the value assisting the norm calculation is added as auxiliary information to the query vector 213 or the vector data 431. Furthermore, the norm of the query vector 213 or the value assisting the norm calculation may be stored as the norm data 432 in the array unit 43.

As described above, the Euclidean distance calculation circuit 451 also functions as a circuit that calculates not only the norm but also the distance between two vectors (calculation of the distance between vectors). The calculation of the distance between vectors is described below in the description of a similarity calculation circuit 453.

It is noted that the Euclidean distance calculation circuit 451 may be a circuit that performs part of calculation of the Euclidean distance between two vectors. The part of calculation of the Euclidean distance between two vectors is calculation where the root calculation (square root calculation) is removed from the Euclidean distance calculation, for example.

Furthermore, the Euclidean distance calculation circuit 451 may be a circuit for calculating any indicator indicating the distance between two vectors, which is not limited to the Euclidean distance. Another indicator indicating the distance between two vectors may be, for example, the Manhattan distance.

The inner product calculation circuit 452 is a circuit that calculates the inner product between two vectors. Specifically, the inner product calculation circuit 452 calculates, for example, the inner product of the query vector 213, and any one vector (search target vector) among the vectors that can serve as targets of the similarity search. For the calculation of the inner product of the query vector and the search target vector, for example, the data of the query vector 213 stored in the query vector storing unit 42, and the data 431 of the search target vector read from the array unit 43 are used. The error correction process by the error correction circuit 44 may be performed for the data 431 of the search target vector read from the array unit 43. The inner product calculation circuit 452 can transmit the calculated inner product to the I/O unit 41.

The vector calculation circuit 45 may further include the similarity calculation circuit 453. The Euclidean distance calculation circuit 451, the inner product calculation circuit 452, and the similarity calculation circuit 453 may be achieved as physically divided three circuits, or achieved as one integrated circuit.

The similarity calculation circuit 453 is a circuit that calculates the similarity between two vectors. Specifically, the similarity calculation circuit 453 calculates, for example, the similarity between the query vector 213 and the search target vector according to Formula (1) described above. (1) The norm data of the query vector 213 and the norm data 432 of the search target vector calculated (obtained) by the Euclidean distance calculation circuit 451, and (2) the inner product of the query vector 213 and the search target vector calculated by the inner product calculation circuit 452, are used for the calculation of the similarity between the query vector 213 and the search target vector. More specifically, the similarity calculation circuit 453 performs calculation of obtaining the COS similarity by dividing the inner product calculation result obtained by the inner product calculation circuit 452 from the query vector 213 and the search target vector, by the size (L2 norm) of the vectors. By performing the calculation of the COS similarity where the vector size is added to the inner product calculation result as described above, more accurate and closer vector search can be achieved. The similarity calculation circuit 453 can transmit the calculated similarity to the I/O unit 41.

The DRAM 5 is a volatile memory. The storage area of the DRAM 5 is allocated as, for example, a storage area of firmware (FW) 51, and a cache area of a logical-physical address conversion table 52. The storage area of the DRAM 5 may further be allocated as a buffer area that temporarily stores user data.

The FW 51 is a program for controlling the operation of the controller 7. The FW 51 is loaded from the semiconductor storage device 4 into the DRAM 5, for example.

The logical-physical address conversion table 52 is a table for managing mapping between logical addresses and physical addresses.

The power source control circuit 6 is a circuit that supplies each configuration element of the memory system 3 with power supplied from the outside, and controls and manages power supplied to each configuration element. The power source control circuit 6 is supplied with power from the host 2, for example. The power source control circuit 6 can supply data (hereinafter, also called power consumption data) indicating the power consumption (amount of power consumption) of each configuration element of the memory system 3, to each component in the controller 7. Specifically, for example, the power source control circuit 6 supplies the power consumption data of the semiconductor storage device 4 to the CPU 15.

The controller 7 may be configured with, for example, a system-on-a-chip (SoC). The controller 7 may be configured with a plurality of semiconductor chips. The controller 7 is electrically connected to the semiconductor storage device 4, and is configured to control the semiconductor storage device 4. The function of each component in the controller 7 may be implemented by dedicated hardware in the controller 7, or implemented by a processor that executes the FW 51.

The controller 7 may function as a flash translation layer (FTL) configured to execute data management and block management of the semiconductor storage device 4. The data management executed by this FTL includes (1) management of mapping information indicating the correspondence relationship between the logical addresses and the respective physical addresses of the semiconductor storage device 4, and (2) a process for hiding the difference between the data read/data write operation in units of pages, and the data erase operation in units of blocks. The block management includes bad block management, wear-leveling, and garbage collection (GC).

The management of mapping between logical addresses and the respective physical addresses is executed using, for example, the logical-physical address conversion table 52. The controller 7 manages the mapping between the logical addresses and the respective physical addresses in a unit of a specific management size, using the logical-physical address conversion table 52. The physical address corresponding to a certain logical address indicates the physical storage position in the semiconductor storage device 4 where data at this logical address is written. The controller 7 manages a plurality of storage areas obtained by logically dividing the storage area of the semiconductor storage device 4, using the logical-physical address conversion table 52. The size of each of the storage areas is the management size described above. These storage areas correspond to the respective logical addresses. That is, each of these storage areas is identified one logical address. The logical-physical address conversion table 52 may be loaded from the semiconductor storage device 4 into the DRAM 5 when the memory system 3 is activated. Data write to one memory cell is allowed only once per P/E cycle. Accordingly, the controller 7 writes updated data corresponding to a certain logical address, not at a physical storage position where previous data corresponding to this logical address is stored, but at another physical storage position. The controller 7 updates the logical-physical address conversion table 52 so as to associate this logical address with the other physical storage position, thus invalidating the previous data. Data referred to by the logical-physical address conversion table 52 (i.e., data associated with the logical address) is called valid data. Data associated with no logical address is called invalid data. The valid data is data that is possibly read later by the host 2. The invalid data is data that is unlikely to be read later by the host 2.

The controller 7 includes, for example, a host interface circuit (host I/F) 11, a DRAM interface circuit (DRAM I/F) 12, a temperature sensor 13, a memory interface circuit (memory I/F) 14, and a CPU 15. These host I/F 11, DRAM I/F 12, temperature sensor 13, memory I/F 14, and CPU 15 are connected to each other via a bus 10, for example.

The host I/F 11 is a communication control circuit configured to control the communication between the host 2 and the memory system 3. The host I/F 11 is a circuit that receives various requests (e.g., I/O commands and control commands) and data from the host 2, and transmits responses to the respective requests, and data to the host 2. The I/O command is, for example, a write command or a read command. The control command is, for example, an UNMAP command (trim command).

The DRAM I/F 12 is a DRAM control circuit configured to control access to the DRAM 5.

The temperature sensor 13 is a sensor that measures the temperature in the memory system 3. The temperature to be measured may be, the temperature itself (e.g., T° C.) or any indicator based on the temperature. The temperature sensor 13 can supply data indicating the measured temperature (hereinafter, also called temperature data) to each component in the controller 7. The temperature sensor 13 may be provided in the semiconductor storage device 4 instead of being provided in the controller 7. In this case, the temperature sensor 13 can measure the temperature in the semiconductor storage device 4, and provide temperature data indicating the measured temperature for each component in the controller 7.

The memory I/F 14 is a storage device control circuit configured to control the semiconductor storage device 4. The memory I/F 14 electrically connects the controller 7 and the semiconductor storage device 4 to each other. The memory I/F 14 conforms to an interface standard, such as Toggle DDR or Open NAND Flash Interface (ONFI).

The memory I/F 14 may be connected to a plurality of semiconductor storage devices 4 via a plurality of signal lines (channels). The plurality of semiconductor storage devices 4 are driven in parallel, thereby allowing the bandwidth of access between the controller 7 and the semiconductor storage device 4 to be increased.

The CPU 15 is a processor configured to control the host I/F 11, the DRAM I/F 12, the temperature sensor 13, and the memory I/F 14. The CPU 15 executes the FW 51 loaded from the semiconductor storage device 4 into the DRAM 5, thereby performing various processes. The FW 51 is a control program that includes a group of instructions for causing the CPU 15 to execute various processes. The CPU 15 can execute command processing and the like for processing various commands (requests) issued by the host 2. The operation of the CPU 15 is controlled by the FW 51 executed by the CPU 15.

The CPU 15 functions as, for example, a request processing unit 151, a response processing unit 152, and a power and temperature control unit 153. The CPU 15 executes, for example, the FW 51, thereby functioning as these components.

The request processing unit 151 receives a request from the host 2 via the host I/F 11. The request is, for example, a data write request, a query vector storing request, or a vector calculation request. The request processing unit 151 instructs each component in the memory system 3 to perform a process according to the received request.

Specifically, for example, upon receipt of the data write request, the request processing unit 151 receives data to be written according to the write request, from the host 2 via the host I/F 11. The request processing unit 151 transfers the received data to the semiconductor storage device 4 via the memory I/F 14. The request processing unit 151 then instructs the semiconductor storage device 4 to perform writing (program) of the transferred data to the array unit 43.

Upon receipt of the query vector storing request, the request processing unit 151 receives data of the query vector 213 to be stored according to the query vector storing request, from the host 2 via the host I/F 11. The request processing unit 151 instructs the semiconductor storage device 4 to store the received data of the query vector 213 to the buffer memory (e.g., the query vector storing unit 42).

Upon receipt of the vector calculation request, the request processing unit 151 instructs the semiconductor storage device 4 to perform calculation of the search target vector designated by the calculation request, and the query vector 213 stored in the query vector storing unit 42. It is noted that the search target vector may be designated by the request processing unit 151 instead of being designated by the calculation request by the host 2. Similar to the search processing unit 222 of the host 2 described above, in this case, the request processing unit 151 determines, for example, one vector sequentially selected from the beginning of the vector list 212 as the search target vector. The vector list 212 is stored in any storage area (e.g., the DRAM 5) in the memory system 3. It is noted that the vector to be searched for next may be in an order according to a search algorithm instead of an order from the beginning of the vector list 212.

The response processing unit 152 transmits a response to the request to the host 2 via the host I/F 11. The response indicates, for example, success or failure of the process in response to the request. The response processing unit 152 can transmit, to the host 2, data obtained by the process performed in response to the request. Data obtained by the process performed in response to the vector calculation request includes, for example, data indicating the inner product of the query vector 213 and the search target vector, and the norm data 432 of the search target vector.

The more specific operations of the request processing unit 151 and the response processing unit 152 are described below with reference to FIGS. 3 and 4.

The power and temperature control unit 153 controls the operation of the semiconductor storage device 4, based on at least one of the power consumption data provided from the power source control circuit 6 and the temperature data provided from the temperature sensor 13. The power consumption data is, for example, data indicating the power consumption of the semiconductor storage device 4 or the entire memory system 3. The temperature data is, for example, data indicating the temperature in the semiconductor storage device 4 or in the memory system 3. By control by the power and temperature control unit 153, for example, at least part of the operation of the semiconductor storage device 4 (e.g., the vector calculation circuit 45) can be stopped, or the operation frequency can be changed.

More specifically, for example, the power and temperature control unit 153 is configured to stop at least part of the operation of the semiconductor storage device 4 in response to the temperature in the semiconductor storage device 4 exceeding a first threshold. Alternatively, the power and temperature control unit 153 is configured to reduce or increase the operation frequency of the vector calculation circuit 45 in response to an increase or decrease in temperature in the semiconductor storage device 4.

For example, the power and temperature control unit 153 is configured to stop at least part of the operation of the semiconductor storage device 4 in response to the power consumption of the semiconductor storage device 4 exceeding a second threshold. Alternatively, the power and temperature control unit 153 is configured to change the operation frequency of the vector calculation circuit 45 in response to an increase or decrease in power consumption of the semiconductor storage device 4. In this case, the power and temperature control unit 153 is configured to reduce the operation frequency of the vector calculation circuit 45 as the power consumption of the semiconductor storage device 4 increases, and to increase the operation frequency of the vector calculation circuit 45 as the power consumption of the semiconductor storage device 4 decreases. It is noted that a circuit that has the function of the power and temperature control unit 153 may be provided in the semiconductor storage device 4.

Referring to FIGS. 3 and 4, the operations performed by the host 2 and the memory system 3 in FIG. 1 are more specifically described.

### (Vector Storing Operation)

FIG. 3 is a sequence diagram showing an example of an operation of the memory system 3 storing vector data from the host 2 and notifying the host 2 of write completion. The vector storing operation is an operation for storing, into the semiconductor storage device 4, the data 431 of the vector that can be a target of the similarity search based on the query vector 213 in FIG. 1. The operation is described below with reference to FIGS. 1 and 3.

First, when a vector to be stored in the semiconductor storage device 4 is present, the storage processing unit 221 of the host 2 issues a write request for the vector (A101). The write request designates, for example, a logical address. The data 431 (vector data 431) of the vector to be stored in the semiconductor storage device 4 is stored in, for example, the DRAM 21.

In the memory system 3, the request processing unit 151 of the controller 7 receives a write request from the host 2 via the host I/F 11. The request processing unit 151 receives the vector data 431 that is to be written in response to the received write request, from the host 2 via the host I/F 11. The request processing unit 151 transfers the received vector data 431 to the semiconductor storage device 4 via the memory I/F 14, and instructs the semiconductor storage device 4 to write the data (A103).

The I/O unit 41 of the semiconductor storage device 4 transmits the vector data 431 to the vector calculation circuit 45 according to the instruction of writing the vector data 431. The Euclidean distance calculation circuit 451 of the vector calculation circuit 45 calculates the norm corresponding to the vector data 431 (A104). The I/O unit 41 then writes the vector data 431, and the norm data 432 indicating the calculated norm, to the array unit 43 (A105). As described above, the Euclidean distance calculation circuit 451 may obtain a value assisting the calculation of the norm of the vector data 431. In this case, the I/O unit 41 writes the vector data 431, and the norm data 432 indicating the value assisting the norm calculation, to the array unit 43. For example, the controller 7 manages the physical address indicating the storing position of the norm data 432 in association with the vector data 431 (e.g., a vector ID). It is noted that the I/O unit 41 writes data where the vector data 431 and the norm data 432 are coupled to each other, to the array unit 43 (more specifically, one page in the array unit 43). The I/O unit 41 notifies the controller 7 of write completion of the vector data 431 (A106).

In response to the write completion of the vector data 431, the response processing unit 152 of the controller 7 updates the logical-physical address conversion table 52 so as to associate the logical address designated by the write request with the physical storage position (physical address) where the vector data 431 is written (A107). The response processing unit 152 notifies the host 2 of write completion of the vector data 431 (A108).

According to the vector storing operation described above, in response to issuance of a write request for the vector data 431 by the host 2, the memory system 3 allows the vector data 431 and the corresponding norm data 432 to be written to the array unit 43 of the semiconductor storage device 4. It is noted that for example, the vector storing operation is repetitively performed for each of multiple items of vector data 431 that are to be written to the array unit 43. That is, in response to issuance of the write request for each of the multiple items of vector data 431 by the host 2, the semiconductor storage device 4 sequentially performs vector norm calculation, and writing of the vector data 431 and the norm data 432 to the array unit 43, for example. Consequently, for example, in a case where each of items of vector data 431 is used as the search target vector, the norm data 432 of the search target vector used to compute the similarity with the query vector 213 can be preliminarily calculated by the vector calculation circuit 45 and stored in the array unit 43.

### (Vector Calculation Operation)

FIG. 4 is a sequence diagram showing an example of an operation of the memory system 3 computing the query vector 213 from the host 2 and transmitting a calculation result to the host 2. The vector calculation operation is an operation for obtaining the similarity between the query vector 213 and the search target vector (vector data 431) stored in the semiconductor storage device 4 in FIG. 1. The operation is described with reference to FIGS. 1 and 4.

First, the search processing unit 222 of the host 2 transmits the input query vector 213 to the memory system 3 (B101). Specifically, for example, the search processing unit 222 transmits data of the query vector 213, along with a request for storing the query vector 213, to the memory system 3.

In the memory system 3, the request processing unit 151 of the controller 7 transmits the query vector 213 received from the host 2, to the semiconductor storage device 4 via the memory I/F 14 (B102). Specifically, for example, the request processing unit 151 instructs the semiconductor storage device 4 to store the query vector 213.

The I/O unit 41 of the semiconductor storage device 4 stores the query vector 213 received from the controller 7 into the query vector storing unit 42 (B103). The I/O unit 41 notifies the controller 7 of completion of storing the query vector 213, or notifies the host 2 via the controller 7.

The search processing unit 222 of the host 2 calculates the norm of the query vector 213 (B104). The norm of the query vector 213 is stored in the DRAM 21, for example. It is noted that the calculation of the norm of the query vector 213 may be performed in parallel with the operations from B101 to B103. Alternatively, the calculation of the norm of the query vector 213 may be performed in parallel with operations from B105 to B112 described below.

The search processing unit 222 selects the search target vector (B105). For example, the search processing unit 222 determines, as the search target vector, one vector sequentially selected from the beginning of the vector list 212. The search processing unit 222 transmits a calculation request about the selected search target vector, to the memory system 3 (B106). The calculation request designates, for example, the vector ID of the search target vector, and the logical address of the data 431 of the search target vector.

In the memory system 3, the request processing unit 151 of the controller 7 receives the calculation request from the host 2 via the host I/F 11. In response to the received calculation request, the request processing unit 151 instructs the semiconductor storage device 4 to perform the vector calculation of the query vector 213 and the search target vector, via the memory I/F 14 (B107).

In the semiconductor storage device 4, the I/O unit 41 reads the data 431 of the search target vector and the norm data 432 of the search target vector from the array unit 43 according to the instruction by the controller 7 (B108). The error correction circuit 44 performs the error correction process for the read vector data 431 and norm data 432 (B109). The inner product calculation circuit 452 of the vector calculation circuit 45 calculates the inner product of the query vector 213 stored in the query vector storing unit 42 and the search target vector (i.e., the vector data 431 having been subjected to the error correction process) (B110). The I/O unit 41 then transmits, to the controller 7, a calculation result that includes the calculated inner product and the norm data 432 of the search target vector (B111).

The response processing unit 152 of the controller 7 receives the calculation result from the semiconductor storage device 4 via the memory I/F 14. The response processing unit 152 transmits the received calculation result to the host 2 via the host I/F 11 (B112). For example, the response processing unit 152 may transmit the calculation result, along with a response indicating that the process in response to the calculation request has succeeded, to the host 2.

The search processing unit 222 of the host 2 receives the calculation result from the memory system 3. The calculation result includes the inner product of the query vector 213 and the search target vector, and the norm data 432 of the search target vector. The search processing unit 222 calculates the similarity between the query vector 213 and the search target vector, using the inner product of the query vector 213 and the search target vector, the norm data 432 of the search target vector, and the norm of the query vector 213 (B113). Specifically, the search processing unit 222 calculates, for example, the similarity by Formula (1) described above.

The search processing unit 222 can easily calculate the similarity between the query vector 213 and the search target vector using the calculation result from the memory system 3. The similarity calculated from Formula (1) indicates that the smaller the value is, the higher the similarity between two vectors a and b is, and the greater the value is, the lower the similarity between two vectors a and b is. It is noted that the operations from B105 to B113 can be repetitively performed for each of the search target vectors indicated by the vector list 212, for example. That is, in response to reading of each of the search target vectors from the array unit 43, the vector calculation circuit 45 sequentially performs the vector calculation (e.g., inner product calculation) of the read search target vector and the query vector 213.

According to the vector calculation operation described above, to obtain the similarity between the query vector 213 and the search target vector, the host 2 transmits the query vector 213 to the memory system 3, and requests calculation of the query vector 213 and the search target vector. The semiconductor storage device 4 of the memory system 3 stores the query vector 213 into the query vector storing unit 42, and calculates the inner product of the query vector 213 and the search target vector in response to the calculation request. The inner product of the query vector 213 and the search target vector, and the preliminarily calculated norm data 432 of the search target vector are transferred from the memory system 3 to the host 2.

Consequently, in the present embodiment, the data indicating the inner product and the norm data 432 are transferred. Accordingly, for example, in comparison with a case where the vector data 431 itself of the search target vector is transferred, the amount of data transferred from the memory system 3 to the host 2 can be reduced. Consequently, the I/O bandwidth of the path for transferring data from the semiconductor storage device 4 to the host 2 via the controller 7 can be prevented from serving as a bottleneck for the vector similarity search.

The CPU 22 (search processing unit 222) of the host 2 calculates the similarity of the query vector 213 and the search target vector using the calculation result received from the memory system 3. The calculation result includes, for example, the inner product of the query vector 213 and the search target vector, and the norm data 432 of the search target vector. Accordingly, the amount of calculation by the CPU 22 to obtain the similarity between the query vector 213 and the search target vector can be reduced.

It is noted that the calculation formula for obtaining the similarity between the query vector 213 and the search target vector is not limited to Formula (1). Any calculation formula capable of representing the similarity between the two vectors that are the query vector 213 and the search target vector can be used as an indicator of the similarity. The vector calculation circuit 45 of the semiconductor storage device 4 is configured to perform at least part of the calculation of obtaining any indicator representing the similarity between the two vectors, and to transmit the calculation result to the controller 7. Accordingly, the vector data 431 itself of the search target vector is not transmitted from the semiconductor storage device 4. Consequently, the amount of data transferred from the memory system 3 to the host 2 can be reduced, and the amount of calculation by the CPU 22 of the host 2 can be reduced.

Here, to clarify the difference in the configuration, operation, and advantageous effects from the present embodiment, an information processing system that includes a memory system according to a comparative example is described. The information processing system that includes the memory system according to the comparative example is described below mainly on a part different from the present embodiment.

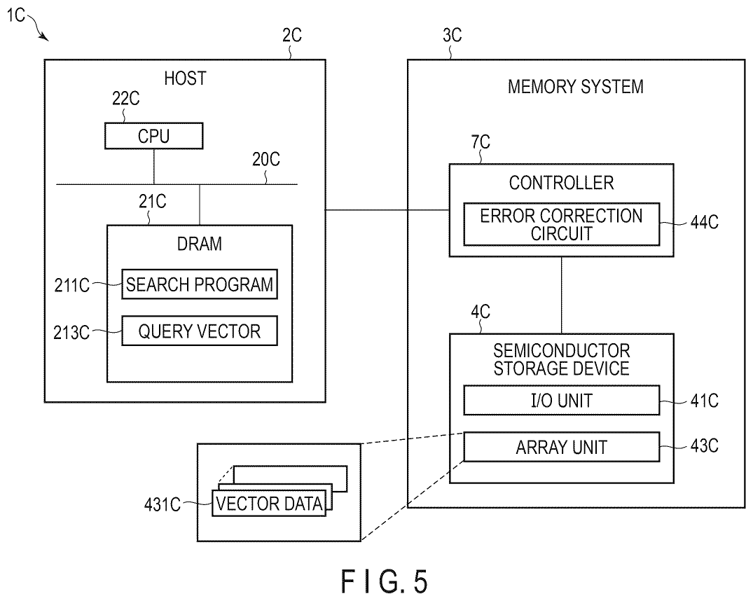

FIG. 5 is a block diagram showing the configuration of the information processing system that includes the memory system according to the comparative example. An information processing system 1C including a memory system 3C according to the comparative example is a system for performing a vector similarity search. The information processing system 1C further includes a host 2C. The host 2C and the memory system 3C are connected to each other via a cable or a network.

The host 2C includes a DRAM 21C and a CPU 22C that are connected to each other via a bus 20C. For example, the CPU 22C executes a search program 211C stored in the DRAM 21C, thereby searching for a vector similar to a query vector 213C from data 431C (vector data 431C) of a plurality of vectors stored in the memory system 3C.

The memory system 3C is used as a storage of the host 2C. The memory system 3C includes a controller 7C, and a semiconductor storage device 4C.

The controller 7C is electrically connected to the semiconductor storage device 4C, and is configured to control the semiconductor storage device 4C. The controller 7C includes an error correction circuit 44C. The error correction circuit 44C performs an error correction process for data read from the semiconductor storage device 4C.

The semiconductor storage device 4C is a storage device that stores data in a non-volatile manner. The semiconductor storage device 4C includes an I/O unit 41C and an array unit 43C.

The I/O unit 41C is a circuit that controls input and output of data into and from the semiconductor storage device 4C. The I/O unit 41C performs an operation according to data input into the semiconductor storage device 4C. The data input into the semiconductor storage device 4C includes a data write instruction, data 431C (vector data 431C) of a vector to be written to the array unit 43C, and a data read instruction. The data output from the semiconductor storage device 4C includes a data write completion signal, a data read completion signal, and the vector data 431C read from the array unit 43C.

The array unit 43C is a memory cell array. The array unit 43C stores multiple items of vector data 431C. Specifically, the vector data 431C is written to the array unit 43C by the I/O unit 41C. The vector data 431C stored in the array unit 43C is read by the I/O unit 41C.

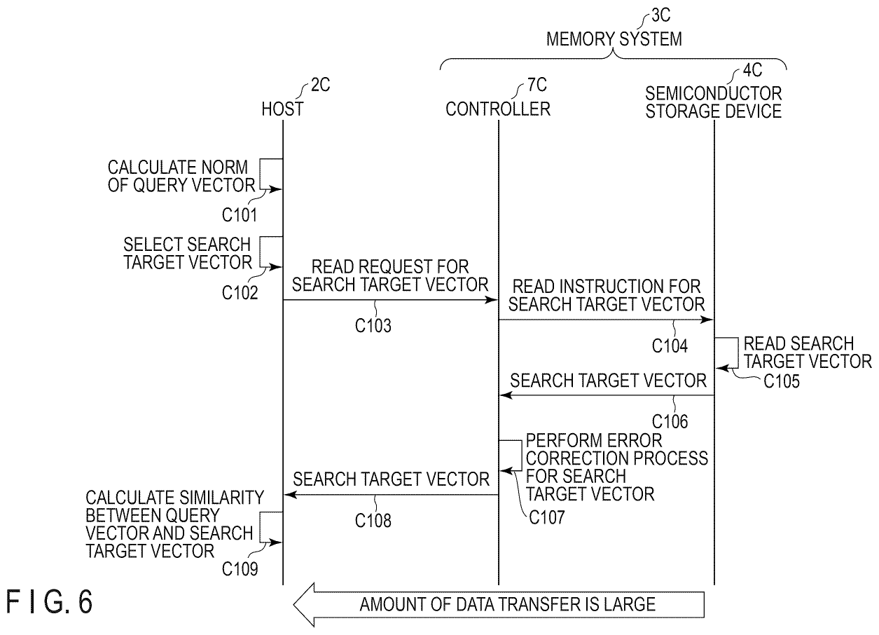

FIG. 6 is a sequence diagram pertaining to a vector calculation operation between the memory system 3C according to the comparative example and the host 2C in FIG. 5. The vector calculation operation is an operation for obtaining the similarity between the query vector 213C and the search target vector (vector data 431C) stored in the semiconductor storage device 4C. The operation is described below with reference to FIGS. 5 and 6.

First, the CPU 22C of the host 2C calculates the norm of the query vector 213C (C101). The CPU 22C selects the search target vector (C102). The CPU 22C then issues a read request for the search target vector (C103). For example, the read request designates the logical address of the search target vector.

The controller 7C of the memory system 3C receives the read request from the host 2C. In response to the read request, the controller 7C instructs the semiconductor storage device 4C to read the search target vector (C104). Specifically, the controller 7C obtains the physical address associated with the logical address designated by the read request, using the logical-physical address conversion table. The controller 7C then instructs the semiconductor storage device 4C to read data from the storage area identified by the obtained physical address.

According to the read instruction by the controller 7C, the I/O unit 41C of the semiconductor storage device 4C reads the vector data 431C of the search target vector from the array unit 43 (C105). The I/O unit 41C transmits the vector data 431C of the read search target vector to the controller 7C (C106).

The controller 7C causes the error correction circuit 44C to perform an error correction process for the vector data 431C of the search target vector (C107). The controller 7C transmits the vector data 431C of the search target vector having been subjected to the error correction process, to the host 2C (C108).

The host 2C receives the vector data 431C of the search target vector from the memory system 3C. The received vector data 431C is stored in a cache of the CPU 22C or the DRAM 21C. The CPU 22C calculates the similarity between the query vector 213C and the search target vector using the norm of the query vector 213C and the vector data 431C of the search target vector (C109). Calculation of the similarity between two vectors is performed by, for example, Formula (1) described above. Specifically, the CPU 22C calculates the norm of the search target vector and calculates the inner product of the query vector 213C and the search target vector. The CPU 22C then calculates the similarity between the query vector 213C and the search target vector using the inner product of the query vector 213C and the search target vector, the norm of the query vector 213C, and the norm of the search target vector.

In the vector calculation operation in the comparative example described above, the host 2C requests the memory system 3C to read the vector data 431C of the search target vector in order to obtain the similarity between the query vector 213C and the search target vector. In response to the read request, the memory system 3C reads the vector data 431C from the semiconductor storage device 4C. The read vector data 431C is transferred from the memory system 3C to the host 2C.

The amount of data of one vector is, for example, several kilobytes. Consequently, in the comparative example, to obtain the similarity between the query vector 213C and one search target vector, data of several kilobytes is transferred from the semiconductor storage device 4C to the controller 7C, and further transferred from the controller 7C (memory system 3C) to the host 2C.

Unlike this, according to the vector calculation operation in the present embodiment described with reference to FIG. 4, in the semiconductor storage device 4 in FIG. 1, at least part of the vector calculation to obtain the similarity between the query vector 213 and the search target vector is performed. Instead of the vector data 431 of the search target vector itself, the result of the vector calculation is then transferred from the semiconductor storage device 4 to the controller 7. The vector calculation result includes, for example, data indicating the inner product of the query vector 213 and the search target vector, and the norm data 432 of the search target vector. The amount of data of the result of the vector calculation is, for example, several bytes. Consequently, in the present embodiment, to obtain the similarity between the query vector 213 and one search target vector, the data of several bytes is transferred from the semiconductor storage device 4 to the controller 7 and further transferred from the controller 7 (memory system 3) to the host 2.

As described above, in the present embodiment, the data of several bytes indicating the result of the vector calculation is transferred. Accordingly, for example, in comparison with the case of transferring the vector data 431C of the search target vector itself, the amount of data transferred from the memory system 3 (more specifically, the semiconductor storage device 4) to the host 2 can be reduced. Consequently, in the present embodiment, the time required for data transfer from the memory system 3 to the host 2 can be reduced, and the amount of power consumed for data transfer can be reduced. For example, in a case where the amount of data of the vector data 431 is 4 KB and the amount of data of the result of the vector calculation is 4 bytes, the amount of transferred data is reduced to 1/1000 thereof. Consequently, in a case where the vector calculation is repetitively requested by the host 2, the reduction in the amount of data to be transferred exerts great advantageous effects. Furthermore, in the present embodiment, the amount of calculation by the CPU 22 of the host 2 to obtain the similarity between the query vector 213 and the search target vector can be reduced.

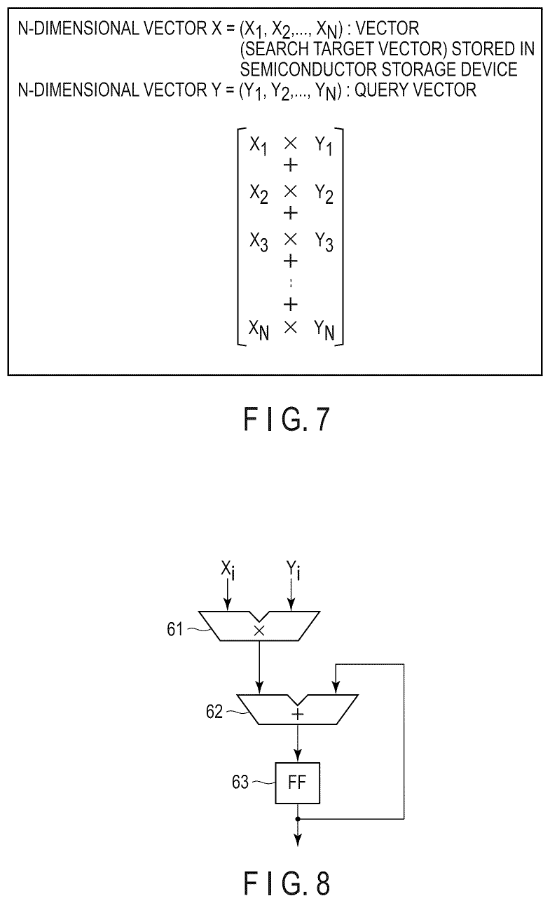

Here, referring to FIGS. 7 to 10, (1) vector inner product calculation, and (2) vector norm calculation by the vector calculation circuit 45 of the semiconductor storage device 4 are specifically described.

### (Inner Product Calculation)

FIG. 7 shows an inner product calculation example by the inner product calculation circuit 452 in the vector calculation circuit 45. Here, a case of calculating the inner product of a vector X and a vector Y is described. The vector X and the vector Y are N-dimensional vectors.

The vector X is assumed as a vector (search target vector) stored in the semiconductor storage device 4. The N elements of the vector X are X₁, X₂, . . . , X_{N}.

The vector Y is assumed as the query vector 213. The N elements of the vector Y are Y₁, Y₂, . . . , Y_{N}.

In this case, as shown in FIG. 7, the inner product of the vector X and the vector Y is obtained by calculating the sum of X₁×Y₁, X₂×Y₂, . . . , X_{N}×Y_{N}. That is, the inner product of the vector X and the vector Y is obtained by the following Formula (3).

$${\sum }_{j = 1}^{N} {X}_{i} {Y}_{i} \qquad Formula ( 3 )$$

FIG. 8 shows an example of logical blocks of the inner product calculation circuit 452 that calculates the inner product. Similar to Formula (3), Xᵢ indicates the i-th element of the vector X, and Yᵢ indicates the i-th element of the vector Y.

The inner product calculation circuit 452 includes, for example, a multiplication unit 61, an addition unit 62, and a flip-flop circuit (FF) 63.

The multiplication unit 61 calculates the product of input two values. The element Xᵢ and the element Yᵢ are input into the multiplication unit 61. More specifically, into the multiplication unit 61, the elements of the vector X are sequentially input from the beginning on a one-by-one basis, and the elements of the vector Y are sequentially input from the beginning on a one-by-one basis. The multiplication unit 61 calculates the product (hereinafter, also called the i-th product) of the input element Xᵢ and element Yᵢ. The multiplication unit 61 outputs the i-th product to the addition unit 62.

The addition unit 62 calculates the sum of the input two values. The i-th product output by the multiplication unit 61, and the value stored in the FF 63 are input into the addition unit 62. It is noted that when the multiplication unit 61 outputs the first product to the addition unit 62, the value stored in the FF 63 is, for example, zero. That is, in the initial state where the inner product calculation is started, for example, zero is stored in the FF 63. The addition unit 62 calculates the sum (hereinafter, also called the i-th sum) of the i-th product and the value stored in the FF 63. The addition unit 62 outputs (stores) the i-th sum to (into) the FF 63.

The FF 63 stores the input value. Specifically, the FF 63 stores the i-th sum input from the addition unit 62. As described above, in the initial state where the inner product calculation is started, for example, zero is stored in the FF 63. Subsequently, the FF 63 stores the i-th sum input from the addition unit 62. The i-th sum is the sum of the first to i-th products.

When the multiplication unit 61 outputs the (i+1)-th product to the addition unit 62, the addition unit 62 reads the i-th sum stored in the FF 63. The addition unit 62 adds together the (i+1)-th product and the i-th sum, thus obtaining the (i+1)-th sum. That is, the addition unit 62 obtains the sum of the first to (i+1)-th products. The addition unit 62 then outputs (stores) the (1+1)-th sum to (into) the FF 63.

The operations of the multiplication unit 61, the addition unit 62, and the FF 63 as described above are performed with the N elements of the vector X and the N elements of the vector Y being adopted as inputs. Accordingly, the sum of the first to N-th products (i.e., the product of Xᵢ×Yᵢ) is finally stored in the FF 63. Consequently, in the inner product calculation circuit 452, the inner product of the vector X and the vector Y is obtained.

### (Norm Calculation)

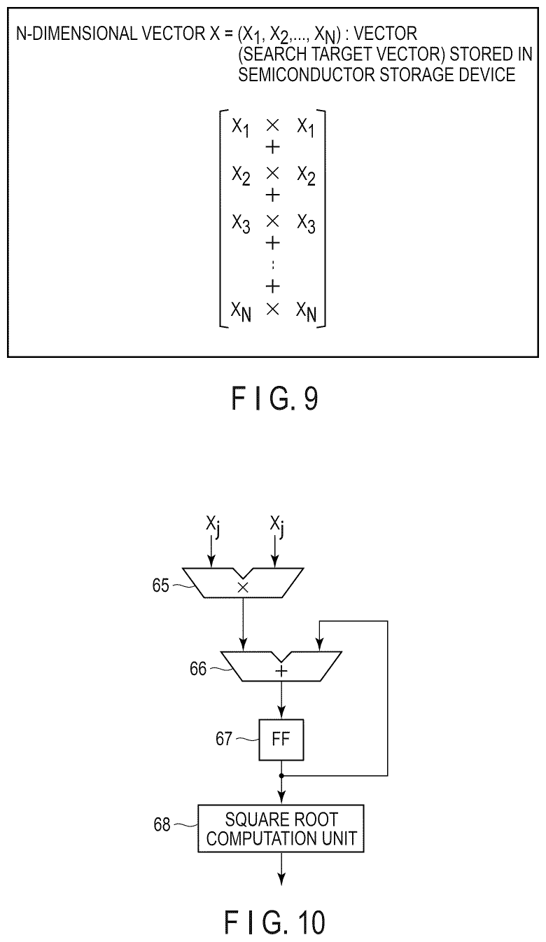

FIG. 9 shows a calculation example for obtaining the norm of the vector by the Euclidean distance calculation circuit 451 in the vector calculation circuit 45. Here, an example in a case of calculating the norm (L2 norm) of the vector X is described. As described above, the vector X is assumed as a vector (search target vector) stored in the semiconductor storage device 4. The N elements of the vector X are X₁, X₂, . . . , X_{N}.

In this case, as shown in FIG. 9, the calculation of the norm of the vector X includes, for example, calculation of the sum of X₁×X₁, X₂×X₂, . . . , X_{N}×X_{N}. That is, the sum is obtained by the following Formula (4).

$${\sum }_{j = 1}^{N} {X}_{i}^{2} \qquad Formula ( 4 )$$

FIG. 10 shows an example of logical blocks of the Euclidean distance calculation circuit 451 that calculates the norm of the vector. The norm of the vector X is the square root of the sum of X₁×X₁, X₂×X₂, . . . , X_{N}×X_{N} described above. Similar to Formula (4), X-indicates the j-th element of the vector X.

The Euclidean distance calculation circuit 451 includes, for example, a multiplication unit 65, an addition unit 66, an FF 67, and a square root calculation unit 68.

The multiplication unit 65 calculates the product of input two values. The element Xⱼ and the element Xⱼ are input into the multiplication unit 65. More specifically, into the multiplication unit 65, the elements of the vector X are sequentially input from the beginning on a one-by-one basis as two elements having the same value. The multiplication unit 65 calculates the product (hereinafter, also called the j-th product) of the input element Xⱼ and element Xⱼ. The multiplication unit 65 outputs the j-th product to the addition unit 66.

The addition unit 66 calculates the sum of the input two values. The j-th product output by the multiplication unit 65, and the value stored in the FF 67 are input into the addition unit 66. It is noted that when the multiplication unit 65 outputs the first product to the addition unit 66, the value stored in the FF 67 is, for example, zero. That is, in the initial state where the norm calculation is started, for example, zero is stored in the FF 67. The addition unit 66 calculates the sum (hereinafter, also called the j-th sum) of the j-th product and the value stored in the FF 67. The addition unit 66 outputs (stores) the j-th sum to (into) the FF 67.

The FF 67 stores the input value. Specifically, the FF 67 stores the j-th sum input from the addition unit 66. As described above, in the initial state where the norm calculation is started, for example, zero is stored in the FF 67. Subsequently, the FF 67 stores the j-th sum input from the addition unit 66. The j-th sum is the sum of the first to j-th products.

When the multiplication unit 65 outputs the (j+1)-th product to the addition unit 66, the addition unit 66 reads the j-th sum stored in the FF 67. The addition unit 66 adds together the (j+1)-th product and the j-th sum, thus obtaining the (j+1)-th sum. That is, the addition unit 66 obtains the sum of the first to (j+1)-th products. The addition unit 66 then outputs (stores) the (j+1)-th sum (into) to the FF 67.

The operations of the multiplication unit 65, the addition unit 66, and the FF 67 as described above are performed with the N elements of the vector X being adopted as inputs. Accordingly, the sum of the first to N-th products (i.e., the product of XjxXj) is finally stored in the FF 67.

The square root calculation unit 68 reads the sum of the first to N-th products from the FF 67. The square root calculation unit 68 then calculates the square root of the sum of the first to N-th products as the norm of the vector X.

Accordingly, in the Euclidean distance calculation circuit 451, the norm of the vector X is obtained. It is noted that the vector calculation circuit 45 may be provided with a calculation circuit that includes the multiplication unit 65, the addition unit 66, and the FF 67 but does not include the square root calculation unit 68, instead of the Euclidean distance calculation circuit 451. The calculation circuit obtains the sum of the first to N-th products. The sum of the first to N-th products corresponds to the data that assists calculation of the norm of the vector X. In this case, instead of the norm, the sum of the first to N-th products is transmitted to the controller 7, or transmitted to the host 2 via the controller 7. In the controller 7 or the host 2, the calculation of the square root of the sum of the first to N-th products is then performed, thereby obtaining the norm of the vector X.

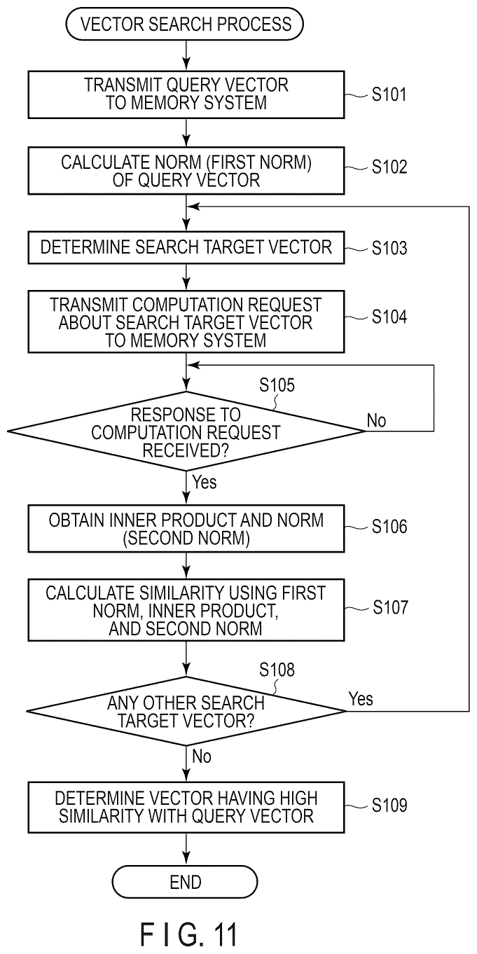

Next, referring to flowcharts in FIGS. 11 to 14, processes executed in the host 2 and the memory system 3 are described.

FIG. 11 is a flowchart showing an example of procedures of the vector search process executed by the CPU 22 of the host 2. The vector search process is a process of searching for one or more vectors similar to the query vector 213 from among the plurality of vectors 431 stored in the memory system 3 (more specifically, the semiconductor storage device 4). The CPU 22 executes the vector search process in response to input of the query vector 213, for example.

First, the CPU 22 transmits the input query vector 213 to the memory system 3 (Step S101). The transmitted query vector 213 is stored in, for example, the query vector storing unit 42 of the semiconductor storage device 4, in the memory system 3. The CPU 22 calculates the norm of the query vector 213 (hereinafter called a first norm) (Step S102).

Next, the CPU 22 determines the search target vector among the plurality of vectors 431 stored in the memory system 3 (Step S103). Specifically, the CPU 22 selects the search target vector from the vector list 212, for example. The search target vector is the target vector whose similarity with the query vector 213 is to be obtained. The CPU 22 transmits a calculation request about the determined search target vector to the memory system 3 (Step S104). The calculation request designates information indicating the search target vector. The information indicating the search target vector includes, for example, the vector ID of the search target vector, and the logical address corresponding to the search target vector. In the semiconductor storage device 4, in response to the calculation request, the vector calculation of the query vector 213 and the search target vector is performed.

The CPU 22 then determines whether the response to the calculation request is received from the memory system 3 or not (Step S105).

If the response to the calculation request is not received (No in Step S105), the processing by the CPU 22 returns to Step S105.

If the response to the calculation request is received (Yes in Step S105), the CPU 22 obtains the inner product of the query vector 213 and the search target vector, and the norm of the search target vector (hereinafter called a second norm) transmitted from the memory system 3 in response to the calculation request (Step S106). It is noted that instead of the second norm, a value assisting the norm calculation of the search target vector may be obtained. The CPU 22 then calculates the similarity between the query vector 213 and the search target vector using the first norm, and the obtained inner product and second norm (Step S107). The calculation of the similarity is performed by, for example, Formula (1) described above.

It is noted that if the response to the calculation request is received (Yes in Step S105), the CPU 22 may obtain the distance (e.g., the Euclidean distance or the Manhattan distance) between the query vector 213 and the search target vector transmitted from the memory system 3 in response to the calculation request. In this case, the CPU 22 uses the obtained distance as the similarity between the query vector 213 and the search target vector.

Next, the CPU 22 determines whether or not there is another search target vector to be subjected to the vector calculation with the query vector 213 (Step S108).

If there is another search target vector (Yes in Step S108), the processing by the CPU 22 returns to Step S103. That is, the CPU 22 continues the processing for calculating the similarity between the other search target vector and the query vector 213.

If there is not another search target vector (No in Step S108), the CPU 22 determines one or more vectors having a high similarity with the query vector 213 from among the plurality of search target vectors whose similarity with the query vector 213 is calculated (Step S109), and ends the vector search process. Specifically, for example, the CPU 22 determines k vectors having the highest similarity with the query vector 213 from among the plurality of search target vectors. k is, for example, an integer greater than or equal to one.

By the vector search process described above, the CPU 22 searches for one or more vectors similar to the query vector 213 from among the plurality of vectors 431 stored in the memory system 3. In the vector search process, instead of the data 431 of the search target vector itself, the result of the vector calculation of the query vector 213 and the search target vector is transferred from the memory system 3 to the host 2. The amount of data of the search target vector is, for example, several kilobytes. Meanwhile, the amount of data of the result of the vector calculation is, for example, several bytes. Consequently, the vector search process according to the embodiment can reduce the amount of data transferred from the memory system 3 to the host 2.

The CPU 22 uses the result of the vector calculation by the semiconductor storage device 4 to calculate the similarity between the query vector 213 and the search target vector. Accordingly, in comparison with the case where the CPU 22C of the host 2C performs all the vector calculations for calculating the similarity between the query vector 213C and the search target vector as with the comparative example, the CPU 22 in the present embodiment can reduce the amount of calculation.

It is noted that, for example, the CPU 22 may execute, in parallel, the processes in Steps S103 and S104 for transmitting the calculation request to the memory system 3, and the processes in Steps S105 to S107 for calculating the similarity using the calculation result in response to the calculation request. More specifically, the CPU 22 may execute, in parallel, the processes for transmitting the plurality of calculation requests to the memory system 3, and the processes for calculating the similarity using the calculation result in response to each of the calculation requests.

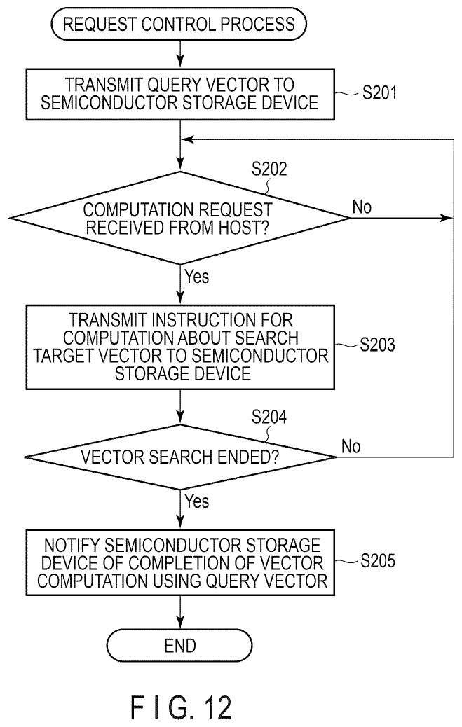

FIG. 12 is a flowchart showing an example of procedures of a request control process executed by the CPU 15 of the memory system 3. The request control process is a process of performing control in response to the calculation request issued by the host 2, for the vector search (similarity search) based on the query vector 213. For example, in response to receipt of the query vector 213 from the host 2, the CPU 15 executes the request control process.

First, the CPU 15 transmits the received query vector 213 to the semiconductor storage device 4 via the memory I/F 14 (Step S201). The transmitted query vector 213 is stored in the query vector storing unit 42 in the semiconductor storage device 4.

Next, the CPU 15 determines whether the calculation request is received from the host 2 or not (Step S202). The calculation request designates the search target vector whose calculation with the query vector 213 is to be performed.

If the calculation request is not received (No in Step S202), the processing by the CPU 15 returns to Step S202. That is, the CPU 15 waits for the calculation request by the host 2.

If the calculation request is received (Yes in Step S202), the CPU 15 transmits an instruction (vector calculation instruction) for performing a calculation about the search target vector designated by the calculation request, to the semiconductor storage device 4 (Step S203). Specifically, for example, the CPU 15 obtains the logical address corresponding to the search target vector from the calculation request. The CPU 15 obtains the physical address associated with the obtained logical address, using the logical-physical address conversion table 52. The CPU 15 then transmits the vector calculation instruction that includes the obtained physical address, to the semiconductor storage device 4. In the semiconductor storage device 4, according to the vector calculation instruction, the vector calculation of the query vector 213 and the search target vector is performed, for example.

Next, the CPU 15 determines whether the vector search based on the query vector 213 is ended or not (Step S204). For example, if the host 2 notifies the memory system 3 of the completion of the vector search based on the query vector 213, the CPU 15 determines that the vector search based on the query vector 213 is ended.

If the vector search based on the query vector 213 is not ended (No in Step S204), the processing by the CPU 15 returns to Step S202. That is, the CPU 15 continues the process in response to the new calculation request by the host 2.

If the vector search based on the query vector 213 is ended (Yes in Step S204), the CPU 15 notifies the semiconductor storage device 4 of the completion of the vector calculation using the query vector 213 (Step S205), and ends the request control process.

According to the request control process described above, the CPU 15 transmits the query vector 213 to the semiconductor storage device 4. The CPU 15 then instructs the semiconductor storage device 4 to perform the vector calculation of the query vector 213 and the search target vector in response to the calculation request by the host 2, until the vector search based on the query vector 213 by the host 2 is ended.

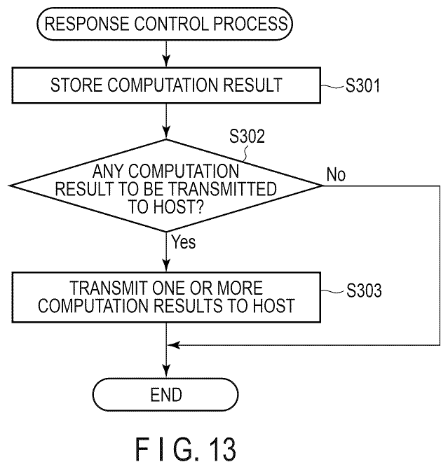

FIG. 13 is a flowchart showing an example of procedures of a response control process executed by the CPU 15 of the memory system 3. The response control process is a process of controlling the response to the calculation request by the host 2. The CPU 15 executes the response control process in response to receipt of the calculation result about the search target vector from the semiconductor storage device 4.

First, the CPU 15 stores the received calculation result (Step S301). Specifically, every time the calculation result is received from the semiconductor storage device 4, the CPU 15 stores the calculation result in association with the corresponding search target vector into, for example, the DRAM 5 (or any storage area in the controller 7). A plurality of calculation results can be stored in the DRAM 5. The calculation result includes, for example, the inner product of the query vector 213 and the search target vector, and the norm data 432 of the search target vector. Alternatively, the calculation result may include the similarity between the query vector 213 and the search target vector.

Next, the CPU 15 determines whether there is a calculation result to be transmitted to the host 2 or not according to a specific rule (Step S302). The specific rule is, for example, a rule such that (1) if the calculation result includes the inner product, the calculation result is transmitted to the host 2, and (2) if the calculation result includes the similarity, k calculation results having the highest similarity among the plurality of calculation results stored until the vector search based on the query vector 213 is ended are transmitted to the host 2.

If there is a calculation result to be transmitted to the host 2 (Yes in Step S302), the CPU 15 transmits one or more calculation results to the host 2 (Step S303), and ends the response control process. The CPU 15 transmits, for example, the calculation result in association with the corresponding calculation request or information that can identify the search target vector, to the host 2. The transmitted calculation result is discarded from the DRAM 5, for example.

If there is no calculation result to be transmitted to the host 2 (No in Step S302), the CPU 15 ends the response control process.

According to the response control process described above, the CPU 15 controls the transmission of the calculation result (i.e., the response to the calculation request) obtained in response to the calculation request, to the host 2. Specifically, when the vector search based on the query vector 213 is performed, the CPU 15 transmits the calculation result of the query vector 213 and the search target vector to the host 2. Accordingly, in comparison with the case of transmitting the data 431 of the search target vector itself from the memory system 3 to the host 2, the amount of data transmitted from the memory system 3 to the host 2 can be reduced.

Furthermore, in the case where the calculation result includes the similarity, the CPU 15 transmits, to the host 2, the k calculation results having the highest similarity among the plurality of calculation results stored until the vector search based on the query vector 213 is ended. In this case, in comparison with all the calculation results are transmitted, the amount of data transmitted from the memory system 3 to the host 2 can be reduced.

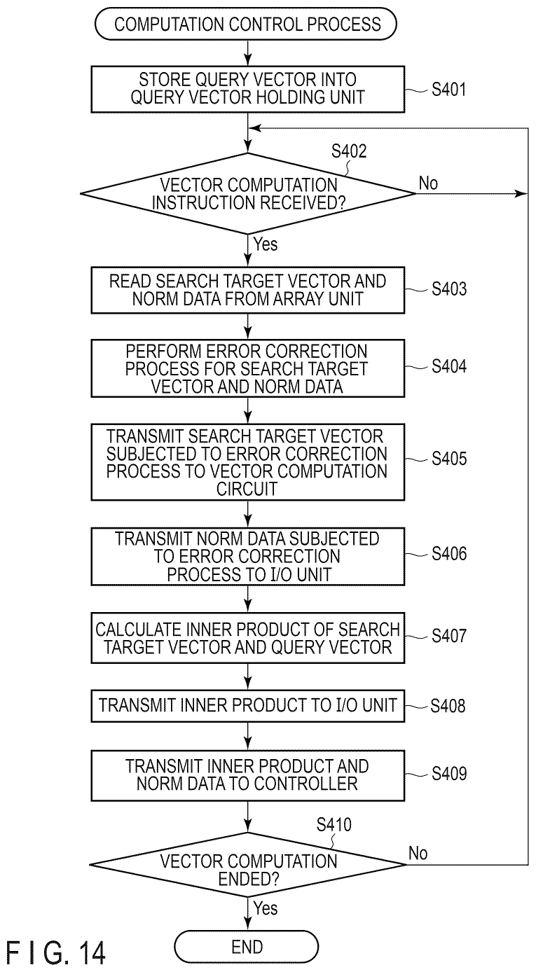

FIG. 14 is a flowchart showing an example of procedures of the calculation control process executed by the semiconductor storage device 4. The calculation control process is a process of controlling the calculation of the query vector 213 and the search target vector. In response to receipt of the query vector 213 from the controller 7, the semiconductor storage device 4 executes the calculation control process. Here, a case where in the calculation control process, the inner product of the query vector 213 and the search target vector, and the norm data 432 of the search target vector are obtained is described as an example.

First, the I/O unit 41 of the semiconductor storage device 4 stores the query vector 213 received from the controller 7 into the query vector storing unit 42 (Step S401). The I/O unit 41 then determines whether the vector calculation instruction is received from the controller 7 or not (Step S402).

If the vector calculation instruction is not received (No in Step S402), the process by the I/O unit 41 returns to Step S402. That is, the I/O unit 41 waits for the vector calculation instruction from the controller 7.

If the vector calculation instruction is received (Yes in Step S402), the I/O unit 41 reads the search target vector and the norm data 432 of the search target vector from the array unit 43, based on the vector calculation instruction (Step S403). Specifically, the I/O unit 41 reads the search target vector (i.e., the vector data 431 of the search target vector) from the array unit 43, based on the physical address designated by the vector calculation instruction. For example, the I/O unit 41 manages the physical address indicating the storing position of the norm data 432 of the search target vector in association with the search target vector.

Consequently, the I/O unit 41 reads the norm data 432 of the search target vector from the array unit 43, based on the physical address associated with the search target vector. The read search target vector and norm data 432 are transmitted to the error correction circuit 44.

It is noted that data where the search target vector and its norm data 432 are coupled to each other may be stored in the array unit 43 (more specifically, a page in the array unit 43). In this case, the I/O unit 41 reads the search target vector along with its norm data 432 from the array unit 43, based on the physical address designated by the vector calculation instruction.

Next, the error correction circuit 44 performs the error correction process for the read search target vector and norm data 432 (Step S404). It is herein assumed that no error is detected in the search target vector and the norm data 432, or a detected error is corrected. The error correction circuit 44 transmits the search target vector subjected to the error correction process, to the vector calculation circuit 45 (Step S405). The error correction circuit 44 transmits the norm data 432 subjected to the error correction process, to the I/O unit 41 (Step S406).

The vector calculation circuit 45 (more specifically, the inner product calculation circuit 452) calculates the inner product of the query vector 213 stored in the query vector storing unit 42 and the search target vector received from the error correction circuit 44 (Step S407). The vector calculation circuit 45 transmits the inner product of the query vector 213 and the search target vector to the I/O unit 41 (Step S408).

The I/O unit 41 transmits the inner product received from the vector calculation circuit 45, and the norm data 432 received from the error correction circuit 44 to the controller 7 (Step S409). The I/O unit 41 then determines whether the vector calculation using the query vector 213 is ended or not (Step S410). Specifically, for example, the I/O unit 41 determines whether the completion of the vector calculation using the query vector 213 is notified by the controller 7 or not.

If the vector calculation using the query vector 213 is not ended (No in Step S410), the process by the I/O unit 41 returns to Step S402. That is, the semiconductor storage device 4 continues the process according to the new vector calculation instruction. Accordingly, in the semiconductor storage device 4, for every vector calculation instruction, the process for the calculation of the query vector 213 and the search target vector is sequentially performed.

If the vector calculation using the query vector 213 is ended (Yes in Step S410), the I/O unit 41 ends the calculation control process. In this case, the I/O unit 41 may discard the query vector 213 stored in the query vector storing unit 42.

According to the calculation control process described above, the semiconductor storage device 4 stores the query vector 213 received from the controller 7 into the query vector storing unit 42. Every time the vector calculation instruction is received from the controller 7, the semiconductor storage device 4 provides the controller 7 with the inner product of the query vector 213 and the search target vector, and the norm data 432 of the search target vector. Specifically, every time the vector calculation instruction is received from the controller 7, the semiconductor storage device 4 reads the search target vector and its norm data 432 from the array unit 43, performs the error correction process for the read search target vector and norm data 432, and calculates the inner product of the query vector 213 and the search target vector. Thus, the inner product of the query vector 213 and the search target vector, and the norm data 432 of the search target vector can be provided for the controller 7. Accordingly, there is no need to transmit the data 431 of the search target vector itself from the semiconductor storage device 4 to the controller 7. Consequently, the amount of data transmitted from the semiconductor storage device 4 to the controller 7 can be reduced.

### Second Embodiment

A second embodiment is different from the first embodiment in that a memory system 3 is provided with a plurality of semiconductor storage devices 4. The other configuration points of the memory system 3 and the host 2 are substantially similar to those of the first embodiment.

According to this configuration, the second embodiment is configured such that the plurality of semiconductor storage devices 4 can perform a plurality of vector calculations in parallel in response to the calculation request by the host 2.

Accordingly, the second embodiment is different from the first embodiment in the procedures of performing the vector calculations in parallel by the plurality of semiconductor storage devices 4. Differences from the first embodiment are mainly described below.

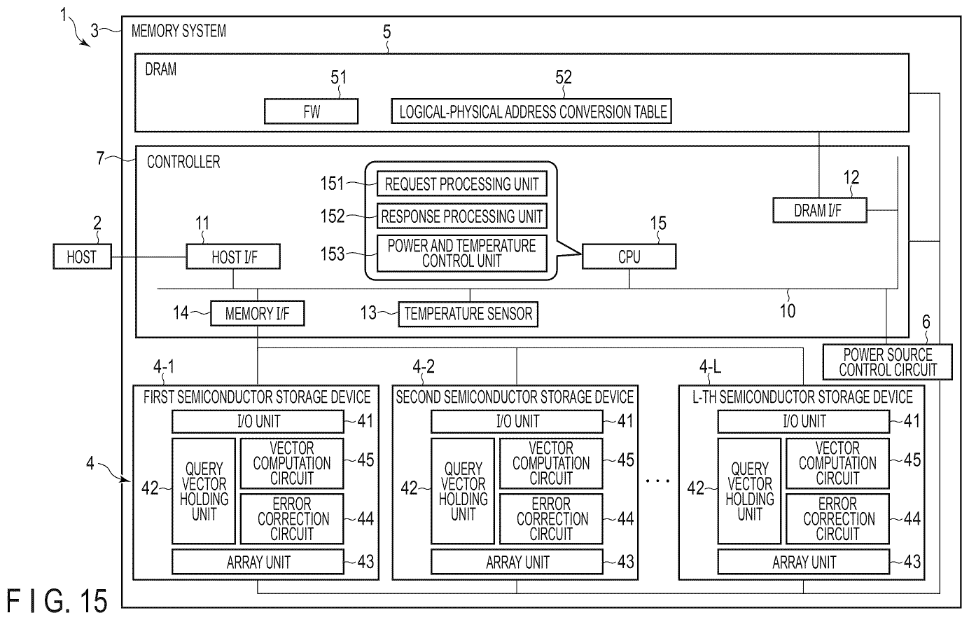

FIG. 15 is a block diagram showing a configuration example of the memory system 3 according to the second embodiment. The memory system 3 includes a plurality of semiconductor storage devices 4, a DRAM 5, a power source control circuit 6, and a controller 7. The plurality of semiconductor storage devices 4 are, for example, L semiconductor storage devices 4-1, 4-2, . . . , 4-L. L is, for example, an integer greater than or equal to two.

The plurality of semiconductor storage devices 4 are connected to the memory I/F 14 of the controller 7 via the same signal line (channel), for example. Each of the semiconductor storage devices 4 has a configuration similar to that of the semiconductor storage device 4 described in the first embodiment. For example, different items of vector data 431 (different vector groups) are stored in a plurality of array units 43 that include non-volatile memory cells and are included in the respective semiconductor storage devices 4.

It is noted that each semiconductor storage device 4 may be provided with a temperature sensor 13. In this case, each temperature sensor 13 can provide the temperature in the corresponding semiconductor storage device 4, for each component (e.g., the CPU 15) in the controller 7.

The power source control circuit 6 supplies power to each of the semiconductor storage devices 4. The power source control circuit 6 can provide data indicating the power consumption of each of the semiconductor storage devices 4, for each component in the controller 7.

The controller 7 is configured to control the semiconductor storage devices 4 in parallel.

Specifically, the controller 7 can control the vector storing operation described with reference to FIG. 3 to be performed in parallel by the plurality of semiconductor storage devices 4. That is, for example, the controller 7 can control the calculation (generation) of the norm data 432 of the vector, and the writing of the vector data 431 and the norm data 432 to the array unit 43 to be performed in parallel by the plurality of semiconductor storage devices 4, in response to the write request for the plurality of vectors (vector data 431) by the host 2.

The controller 7 can control the vector calculation operation described with reference to FIG. 4 to be performed in parallel by the plurality of semiconductor storage devices 4. That is, for example, the controller 7 can control the calculation of the query vector 213 and the search target vector to be performed in parallel by the plurality of semiconductor storage devices 4 in response to the calculation request for the plurality of vectors by the host 2.

It is noted that the query vectors 213 stored in the query vector storing units 42 of the respective semiconductor storage devices 4 may be the same as or different from each other. That is, the plurality of semiconductor storage devices 4 may perform the vector calculations in parallel using the same query vector 213 and the search target vectors in the respective semiconductor storage devices 4, or perform the vector calculations in parallel using the different query vectors 213 and the search target vectors in the respective semiconductor storage devices 4.

In other words, the host 2 (more specifically, the search processing unit 222 of the CPU 22) can transmit the same query vector 213 to the plurality of semiconductor storage devices 4 via the controller 7, and cause these devices to perform the vector calculations using the same query vector 213 in parallel. The host 2 can transmit the different query vectors 213 to the respective semiconductor storage devices 4 via the controller 7, and cause these devices to perform the vector calculations using the different query vectors 213 in parallel.

In the case where the plurality of semiconductor storage devices 4 perform the vector calculation operations in parallel, the host 2 can issue, to the controller 7, an instruction of a rule for transmitting the calculation result to the host 2. For example, the rule specifies transfer of the calculation results corresponding to the respective vector calculation operations in a specific order to the host 2, or transfer of the calculation result satisfying a specific condition among the calculation results to the host 2. The plurality of calculation results are stored in, for example, the DRAM 5.

Specifically, for example, in the case where the plurality of semiconductor storage devices 4 perform the vector calculation operations respectively based on the different query vectors 213 in parallel, the host 2 instructs the controller 7 to sequentially transfer, to the host 2, the calculation results for the respective query vectors 213 in an order set for these query vectors 213.

For example, in the case where the plurality of semiconductor storage devices 4 perform the vector calculation operations based on the same query vector 213 in parallel (speculatively), the host 2 instructs the controller 7 to transfer, to the host 2, at least one calculation result selected based on the specific condition from among the calculation results. The specific condition is, for example, a condition that the calculation results are k calculation results having the highest similarity. It is noted that in the case where the plurality of semiconductor storage devices 4 perform the vector calculation operations based on the same query vector 213 in parallel, and each calculation result includes the inner product instead of the similarity between the query vector 213 and the search target vector, the host 2 instructs the controller 7 to transfer all the calculation results to the host 2.

The response processing unit 152 of the controller 7 is configured to transfer the calculation result to the host 2 according to the instruction of such a rule. For example, the response processing unit 152 discards the calculation result transferred to the host 2, from the DRAM 5. In the case where the response processing unit 152 transfers, to the host 2, k calculation results having the highest similarity among the calculation results, the response processing unit 152 discards, from the DRAM 5, not only the transferred k calculation results but also the other calculation results having not been selected, for example.

As described above, similar to the memory system 3 in the first embodiment, the memory system 3 in the second embodiment can reduce the amount of data transferred from the semiconductor storage device 4 to the controller 7, and the amount of data transferred from the memory system 3 (more specifically, the controller 7) to the host 2. In the case where the plurality of semiconductor storage devices 4 are connected to the controller 7 via the same signal line, there is a limit to the amount of simultaneously transferable data. In such a case, by transferring the calculation result of the vector calculation instead of the vector data 431 of the search target vector itself, the I/O bandwidth of the path along which data is transferred from the plurality of semiconductor storage devices 4 to the host 2 can be prevented from serving as a bottleneck for the vector similarity search.

The memory system 3 in the second embodiment transfers the calculation result obtained by narrowing down the plurality of calculation results obtained in response to the respective calculation requests with the specific condition, which can further reduce the amount of data transferred from the memory system 3 to the host 2. Furthermore, the memory system 3 in the second embodiment causes the plurality of semiconductor storage devices 4 to operate in parallel in the similarity search based on one or more query vectors 213, thereby allowing the resources of these semiconductor storage device 4 to be effectively utilized.

### Third Embodiment

A memory system 3 according to a third embodiment is different from that in the first embodiment and the second embodiment in that a vector calculation semiconductor storage device 4 that performs a vector calculation, and a general-purpose semiconductor storage device 4G are separately provided. The other configuration points of the memory system 3 and the host 2 are substantially similar to those of the first embodiment and the second embodiment.

It is noted that the general-purpose semiconductor storage device 4G is a storage device that stores vector data but is not provided with a configuration for the vector calculation.

According to the configuration described above, the third embodiment is different from the first and second embodiments in procedures of a process of causing the vector calculation semiconductor storage device 4 to perform the vector calculation using vector data stored in the general-purpose semiconductor storage device. Differences from the first embodiment and the second embodiment are mainly described below.

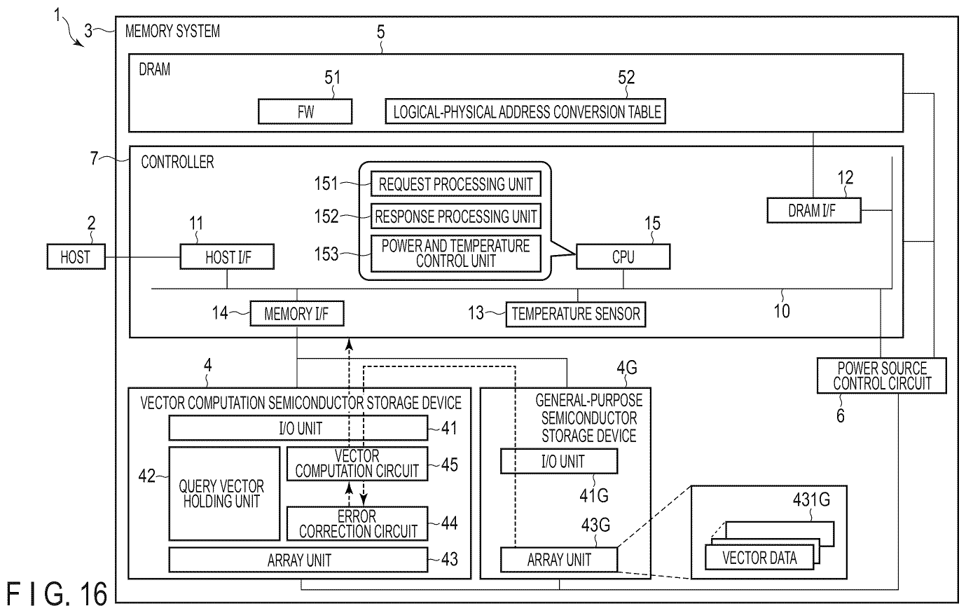

FIG. 16 is a block diagram showing a configuration example of the memory system 3 according to the third embodiment. The memory system 3 includes at least one vector calculation semiconductor storage device 4, at least one general-purpose semiconductor storage device 4G, a DRAM 5, a power source control circuit 6, and a controller 7.

The vector calculation semiconductor storage device 4 and the general-purpose semiconductor storage device 4G are connected to a memory I/F 14 of the controller 7 via, for example, the same signal line. It is noted that the vector calculation semiconductor storage device 4 and the general-purpose semiconductor storage device 4G may be connected to the memory I/F 14 of the controller 7 via different signal lines.

The vector calculation semiconductor storage device 4 has a configuration similar to that of the semiconductor storage device 4 described in the first embodiment. It is noted that the error correction circuit 44 can perform an error correction process not only for data read from the array unit 43 but also for data received from the outside (e.g., the general-purpose semiconductor storage device 4G) via the I/O unit 41.

The general-purpose semiconductor storage device 4G includes, for example, an I/O unit 41G and an array unit 43G.

The I/O unit 41G is a circuit that controls input and output of data into and from the general-purpose semiconductor storage device 4G. The I/O unit 41G can instruct each component of the general-purpose semiconductor storage device 4G to perform an operation in accordance with data input into the general-purpose semiconductor storage device 4G.

The data input into the general-purpose semiconductor storage device 4G is, for example, an instruction, or data to be written to the array unit 43G. The instruction is, for example, a data write instruction or a data read instruction. The data to be written to the array unit 43G is, for example, vector data 431G.

The data output from the general-purpose semiconductor storage device 4G is a response to an instruction, or data read from the array unit 43G. The response to the instruction is, for example, a data write completion signal or a data read completion signal. The data read from the array unit 43G is, for example, the vector data 431G.

The array unit 43G is a memory cell array including a plurality of non-volatile memory cells. The array unit 43 is configured with one or more non-volatile memory chips. The array unit 43G stores, for example, items of the vector data 431G (i.e., a plurality of vectors).

It is noted that for example, different items of vector data (different vector groups) are stored in the array unit 43 of the vector calculation semiconductor storage device 4, and the array unit 43G of the general-purpose semiconductor storage device 4G.

Each of the vector calculation semiconductor storage device 4 and the general-purpose semiconductor storage device 4G may be provided with a temperature sensor 13. In this case, each temperature sensor 13 can measure the temperature in the corresponding semiconductor storage device 4 or 4G, and provide temperature data indicating the measured temperature to each component in the controller 7.

The power source control circuit 6 supplies power to the vector calculation semiconductor storage device 4 and the general-purpose semiconductor storage device 4G. The power source control circuit 6 can provide each component of the controller 7 with power consumption data indicating the power consumptions of the vector calculation semiconductor storage device 4 and the general-purpose semiconductor storage device 4G.

The controller 7 is configured to control the vector calculation semiconductor storage device 4 and the general-purpose semiconductor storage device 4G in parallel.

Here, an operation in a case where the host 2 transmits, to the memory system 3, a calculation request designating the vector data 431G stored in the general-purpose semiconductor storage device 4G as the search target vector is described.

The request processing unit 151 of the controller 7 receives the calculation request from the host 2 via the host I/F 11. In response to the received calculation request, the request processing unit 151 instructs, via the memory I/F 14, the general-purpose semiconductor storage device 4G to read the vector data 431G designated as the search target vector.

According to the instruction by the controller 7, the I/O unit 41G of the general-purpose semiconductor storage device 4G reads the data 431G of the search target vector from the array unit 43G. The read vector data 431G is transferred as the search target vector to the vector calculation semiconductor storage device 4. It is noted that in a case where the memory system 3 is provided with a plurality of vector calculation semiconductor storage devices 4, the vector data 431G is transferred to the vector calculation semiconductor storage devices 4 connected to the controller 7 by the same signal line as that of the general-purpose semiconductor storage device 4G, for example. Accordingly, the amount of power consumption required to transfer the vector data 431G can be reduced.

In the vector calculation semiconductor storage device 4, the I/O unit 41 transmits, to the error correction circuit 44, the vector data 431G of the search target vector transferred from the general-purpose semiconductor storage device 4G. The error correction circuit 44 performs an error correction process for the vector data 431G. The error correction circuit 44 can transmit the vector data 431G having been subjected to the error correction process, to the vector calculation circuit 45.

The inner product calculation circuit 452 of the vector calculation circuit 45 calculates the inner product of the query vector 213 stored in the query vector storing unit 42 and the search target vector (i.e., the vector data 431G having been subjected to the error correction process). The Euclidean distance calculation circuit 451 calculates (generates) the norm data 432 of the search target vector. Alternatively, the norm data 432 of the search target vector may be preliminarily calculated by the Euclidean distance calculation circuit 451, and be stored in the array unit 43G of the general-purpose semiconductor storage device 4G. In this case, the norm data 432 of the search target vector is read from the array unit 43G of the general-purpose semiconductor storage device 4G, and transferred to the vector calculation semiconductor storage device 4. An error correction process by the error correction circuit 44 may be performed for the transferred norm data 432.

The I/O unit 41 transmits, to the controller 7, a calculation result that includes the calculated inner product and the norm data 432 of the search target vector.

The response processing unit 152 of the controller 7 receives the calculation result from the semiconductor storage device 4 via the memory I/F 14. The response processing unit 152 transmits the received calculation result to the host 2 via the host I/F 11.

As described above, in the memory system 3 in the third embodiment, the vector calculation semiconductor storage device 4 and the general-purpose semiconductor storage device 4G are separately provided in the memory system 3, and even when a vector calculation with the vector data 431G stored in the general-purpose semiconductor storage device 4G being adopted as the search target vector is requested by the host 2, the memory system 3 (more specifically, the controller 7) transfers the vector calculation result to the host 2. Specifically, the general-purpose semiconductor storage device 4G reads the vector data 431G of the search target vector from the array unit 43G, and transmits the read data to the vector calculation semiconductor storage device 4. The vector calculation semiconductor storage device 4 then performs the vector calculation of the query vector 213 and the search target vector using the transferred vector data 431G, and transmits the calculation result to the controller 7. Thus, the calculation result is transferred from the memory system 3 to the host 2. Accordingly, in comparison with the case where the vector data 431G itself is transferred, the amount of data transferred from the memory system 3 to the host 2 can be reduced.

As described above, according to the first to third embodiments, the amount of data transferred to the host 2 can be reduced in the case of searching for the vector (vector data 431) that is in the memory system 3 and is similar to the query vector 213.

The one or more semiconductor storage devices 4 each include the non-volatile array unit 43 that stores the data 431 of N-dimensional vectors. Each semiconductor storage device 4 receives data of the N-dimensional first query vector 213 from the host 2 via the controller 7. Each semiconductor storage device 4 stores the data of the first query vector 213 into the buffer memory (e.g., the query vector storing unit 42). Each semiconductor storage device 4 performs the first vector calculation using the data of the first query vector 213, and the data 431 of the first vector (search target vector) among the N-dimensional vectors. Each semiconductor storage device 4 transmits data indicating the result of the first vector calculation to the host 2 via the controller 7.

Thus, the calculation result of the first query vector 213 and the first vector is transferred from the semiconductor storage device 4 to the host 2. Accordingly, the amount of transferred data can be reduced in comparison with the case where the data 431 of the first vector is transferred from the semiconductor storage device 4 to the host 2. Consequently, the I/O bandwidth of the path for transferring data from the semiconductor storage device 4 to the host 2 via the controller 7 can be prevented from serving as a bottleneck for the vector similarity search. The host 2 calculates, for example, the similarity between the first query vector 213 and the first vector using the calculation result, which can reduce the amount of calculation in the host 2.

Each of the various functions described in the first to third embodiments may be implemented by a circuit (processing circuit). Examples of the processing circuit include a programmed processor, such as a central processing unit (CPU). The processor executes each of the described functions by executing a computer program (instruction group) stored in the memory. The processor may be a microprocessor that includes electric circuits. Examples of the processing circuit include a digital signal processor (DSP), an application specific integrated circuit (ASIC), a microcontroller, a controller, and another electric circuit component. Each of the components other than the CPU that are described in these embodiments may also be implemented by a processing circuit.

While certain embodiments have been described, these embodiments have been presented by way of example only, and are not intended to limit the scope of the inventions. Indeed, the novel devices and methods described herein may be embodied in a variety of other forms; furthermore, various omissions, substitutions, and changes in the form of the embodiments described herein may be made without departing from the spirit of the inventions. The accompanying claims and their equivalents are intended to cover such forms or modification as would fall within the scope and spirit of the invention.

What is claimed is:

1. A memory system, comprising:
a semiconductor storage device including a buffer memory, a non-volatile memory cell array, and a vector calculation circuit; and
a controller electrically connected to the semiconductor storage device and communicable with a host that is external to the memory system, the controller being configured to:
store a plurality of N-dimensional vectors (N is an integer more than or equal to one) in the non-volatile memory cell array;
receive a query vector, which is N-dimensional, from the host;
store the query vector into the buffer memory;
control the vector calculation circuit to perform a first vector calculation with respect to the query vector and a first vector among the plurality of N-dimensional vectors stored in the non-volatile memory cell array; and
transmit a result of the first vector calculation to the host.

2. The memory system according to claim 1, wherein the semiconductor storage device further includes an error correction circuit configured to perform an error correction process with respect to the first vector.

3. The memory system according to claim 2, further comprises:
a second semiconductor storage device including a second non-volatile memory cell array configured to store a second plurality of N-dimensional vectors, wherein
the controller is configured to:
read a second vector among the second plurality of N-dimensional vectors stored in the second non-volatile memory cell array;
control the vector calculation circuit to perform a second vector calculation with respect to the query vector and the second vector; and
transmit a result of the second vector calculation to the host.

4. The memory system according to claim 3, wherein the second semiconductor storage device does not include any vector calculation circuit.

5. The memory system according to claim 1, wherein the first vector calculation includes a calculation of a norm of the first vector or a value obtained during the calculation of the norm, and a calculation of an inner product of the query vector and the first vector.

6. The memory system according to claim 1, wherein the first vector calculation includes a calculation of any one of an Euclidean distance or a Manhattan distance between the query vector and the first vector, or a value obtained during the calculation of the Euclidean distance or the Manhattan distance.

7. The memory system according to claim 1, wherein the controller is configured to:
cause a different one of first vectors among the plurality of N-dimensional vectors to be read from the non-volatile memory cell array; and
control the vector calculation circuit to sequentially perform the first vector calculation with respect to the query vector and each of the first vectors.

8. The memory system according to claim 1, wherein the vector calculation circuit includes:
a first calculation circuit configured to calculate a norm of the first vector or a value obtained during the calculation of the norm, and calculate an inner product of the query vector and the first vector; and
a second calculation circuit configured to calculate any one of an Euclidean distance or a Manhattan distance between the query vector and the first vector, or a value obtained during the calculation of the Euclidean distance or the Manhattan distance.

9. The memory system according to claim 1, wherein the vector calculation circuit includes:
a first calculation circuit configured to calculate a norm of the first vector or a value obtained during the calculation of the norm,
a second calculation circuit configured to calculate an inner product of the query vector and the first vector; and
a third calculation circuit configured to calculate any one of an Euclidean distance or a Manhattan distance between the query vector and the first vector, or a value obtained during the calculation of the Euclidean distance or the Manhattan distance.

10. The memory system according to claim 1, wherein the controller is configured to:
control the vector calculation circuit to perform a third vector calculation with respect to a third vector requested by the host to be written to the semiconductor storage device; and
store the third vector and a result of the third vector calculation into the non-volatile memory cell array.

11. The memory system according to claim 10, wherein the third vector calculation includes a calculation of a norm of the first vector, or a value obtained during the calculation of the norm.

12. The memory system according to claim 1, wherein
the non-volatile memory cell array includes a plurality of blocks, and
each of the plurality of N-dimensional vectors in the non-volatile memory cell array is stored in one, but not more than one, of the plurality of blocks.

13. The memory system according to claim 12, wherein
each of the plurality of blocks includes a plurality of pages, and
each of the plurality of N-dimensional vectors is stored in one, but not more than one, of the plurality of pages.

14. The memory system according to claim 1, further comprising:
a temperature sensor, wherein
the controller is further configured to control operations of the vector calculation circuit based on temperature data obtained from the temperature sensor.

15. The memory system according to claim 14, wherein the controller is configured to change an operation frequency of the vector calculation circuit based on the temperature data.

16. The memory system according to claim 1, further comprising:
a power control circuit, wherein
the controller is further configured to control operations of the vector calculation circuit based on power consumption data obtained from the power control circuit.

17. The memory system according to claim 16, wherein the controller is configured to change an operation frequency of the vector calculation circuit based on the power consumption data.

18. The memory system according to claim 1, wherein
the memory system comprises a plurality of the semiconductor storage devices, each of which includes the buffer memory, the non-volatile memory cell array storing the plurality of N-dimensional vectors, and the vector calculation circuit, and
the controller is configured to control the vector calculation circuits of the plurality of semiconductor storage devices to perform a vector calculation in parallel.

19. The memory system according to claim 18, wherein
the controller is configured to:
control the vector calculation circuits of the plurality of semiconductor storage devices to perform the first vector calculation in parallel;
select at least one of the results of the first vector calculations performed by the vector calculation circuits of the plurality of semiconductor storage devices; and
transmit the selected at least one of the results of the first vector calculations to the host.

20. The memory system according to claim 1, wherein the controller is configured to not transmit data of the first vector to the host when transmitting the result of the first vector calculation to the host.
